(19) United States
(12) Patent Application Publication
(10) Pub. No.: US 2010/0251486 A1
(43) Pub. Date: Oct. 7, 2010

(54) LAUNDRY ARTICLE

(75) Inventors: Katherine G. Yu, Phoenix, AZ (US); Cornelius Bessler, Scottsdale, AZ (US); Matthew M. Petkus, Scottsdale, AZ (US); Lizette M. Bonvin, Scottsdale, AZ (US)

Correspondence Address: THE DIAL CORPORATION, 19001 N. Scottsdale Road, SCOTTSDALE, AZ, 85255, US

(73) Assignee: The Dial Corporation, Scottsdale, AZ (US)

(21) Appl. No.: 12/792,370

(22) Filed: Jun. 2, 2010

Related U.S. Application Data
(63) Continuation-in-part of application No. 12/225,043, filed on Jan. 27, 2009.
(60) Provisional application No. 60/792,284, filed on Apr. 14, 2006.

(51) Int. Cl. D06L 1/04; C11D 17/00

(52) U.S. Cl. 8/137; 510/298

(57) ABSTRACT

A laundry article of manufacture is described that may be used to both wash and condition fabrics when used sequentially first in the washer and then carried along with the wet fabrics into the dryer. The laundry article preferably comprises at least one detergent and at least one softener composition each solidified into geographical zones onto a nonwoven substrate. The optimized article comprises a nonwoven substrate with sidedness, and although the softener composition is solidified within the fibers of the lofted side of the substrate, the softener is unexpectedly found to subsequently express out from the flat side of the substrate while in the heated clothes dryer.

### CROSS-REFERENCE TO RELATED APPLICATIONS

This application is a continuation-in-part of U.S. Application Serial No. 12/225,043, filed on Jan. 27, 2009, which is the U.S. national phase entry of International Application No. PCT/US2007/009225, filed Apr. 16, 2007, which claims benefit of U.S. Provisional Application Ser. No. 60/792,284, filed Apr. 14, 2006.

### FIELD OF THE INVENTION

The present invention relates to an article of manufacture used for both cleaning and conditioning fabrics. More specifically the article comprises a water-insoluble substrate coated with detergent, fabric softener, and optionally other fabric treatment compositions, which functions as a single product for washing and conditioning fabrics when added to the washing machine and then carried along with the wet clothes into the clothes dryer. The invention also relates to methods of manufacturing such articles.

### BACKGROUND OF THE INVENTION

The laundering process, whether conducted by the homemaker in residential homes or conducted by staff in institutional laundry facilities such as hospitals, hotels, prisons and the like, requires a first washing step with a laundry detergent and a subsequent drying step in a clothes dryer. Normally a laundry detergent, for example powdered, liquid or in unitized dose form such as a tablet, is added to the laundry washing machine with the soiled clothing and cold, warm or hot water for the washing step, and then the wet fabrics are transferred over to a clothes dryer where a separate fabric softener/antistatic agent is added, for example as a dryer sheet. One way to provide for both the cleaning and conditioning of fabrics from a single product is to have a laundry, detergent with fabric softener built into the liquid or powdered composition. An alternative procedure that also eliminates adding chemical materials to the dryer is to have separate detergent and fabric conditioning products added to the washing machine, for example taking advantage that some washing machines have a separate compartment for the fabric softener so that it is held back during the washing process and added during the rinse cycle.

It is widely desired to have both the detergent and the conditioning agent in a single product, and have it perform better than a detergent with built-in fabric softener or separate detergent and fabric softener used in the washer, as described above. It is most desirable to have detergent and conditioning formulations on a substrate that in some ways physically resembles a fabric softener dryer sheet, where the substrate is added to the washing machine and the detergent is liberated into the washing liquor, and where the substrate is then carried along with the wet fabrics into the dryer where the fabric conditioning composition is liberated into the fabrics by the heat of the dryer. Heretofore the prior art has only described such laundry sheets that are tacky to the touch, difficult to manufacture due to the need to sandwich layers, and inefficient at cleaning and conditioning fabrics. What is required is the combination of builder, detergent and fabric softener/anti-stat on a sheet that is easy to manufacture, is a pleasure to handle and not sticky to the touch, and that has superior cleaning along with superior and substantive antistatic, fragrance and softener delivery in the drying cycle.

So called laundry articles that are added to the automatic washing machine and then subsequently carried into the dryer with the wet fabrics in order to provide cleaning and fabric softening and antistatic control benefits from a single article are known in the prior art and in the market. For example, U.S. Pat. No. 4,095,946 issued on Jun. 20, 1978 (Jones '946) to The Procter & Gamble Company describes a laundry article that provides both cleaning and fabric conditioning benefits, and which is used in both the automatic washer and dryer during the laundering process. The Jones '946 patent describes an article consisting primarily of a water-insoluble substrate: with a detergent composition having a water-soluble surfactant mixture comprising sodium dodecylbenzene sulfonate (Na-LAS), sodium alcohol ether sulfate (Na-AES), silicate and phosphate, or alcohol ethoxylate nonionic and magnesium dodecylbenzene sulfonate (Mg-LAS), along with a fabric conditioning mixture comprising a quaternary and a fatty alcohol dispersion inhibitor. Such articles liberate their detergent compositions in the wash water of the laundry machine while the fabric softener composition, being somewhat insoluble in the wash liquor, survives the wash conditions and is therefore available to condition the fabrics when the wet fabrics are dried in the clothes dryer along with this article that has been carried along. The Jones '946 patent describes only examples that require sandwiched substrate layers to hide the tacky detergent composition. The detergent compositions in the Jones '946 patent are aqueous liquids or slurries, and are either sprayed on or smeared as a wet slurry onto the substrates, then sandwiched with another layer of substrate, then either stitched together at the outside edge (if pulp/cotton) or heat-sealed if polypropylene, and dried extensively to remove the water and reduce the overall weight of the article. The softener mix is a melt formed by co-Melting the quaternary softener with the fatty alcohol dispersion inhibitor and the melt is applied as drips onto the outside of the sandwiched article where the mixture solidifies upon cooling. Clearly this involved multi-step process would not be amenable to producing a low cost marketable product.

Additionally, U.S. Pat. No. 4,170,565 issued on Oct. 9, 1979 to The Procter & Gamble Company (Flesher '565) also describes an article of manufacture comprising a water-insoluble substrate impregnated with detergents and fabric conditioners that is claimed useful in a process for cleaning fabrics. Flesher '565 describes articles having identical compositions to those described in the Jones '946 patent, but more importantly describes in more details the requirements for air permeability of the substrate. Flesher '565 describes articles made from melt-blown polypropylene sheets with air permeability ranging from 19-175 cubic feet per minute per square foot. The Flesher '565 patent describes the same need to layering and seeming together of layers so that the sticky detergent composition is blocked from touch. Interestingly, these references along with some other patents mentioned below, do not mention the need for substantive fragrance delivery in the dryer or delineate ways to optimize the retention of the softener through the wash and how to maximize the delivery of the softener off the substrate in the dryer. Clearly the prior art does not describe the need for getting scent into the dryer nor does the prior art show how to accomplish superior fragrance and antistatic delivery in the dryer from a laundry sheet that has gone through a wash cycle.

State of the art powdered, solid, liquid and unitized dose (tablet, pouch and sheet) detergents continue to face additional problems. Most problematic is that fragrance delivery to the fabrics through the wash is limited. The only practical method to obtain heavily scented clothing is to use several heavily scented dryer sheets in the clothes dryer at one time. Detergents that deliver fragrance to the wash liquor do not deliver fragrance that is substantive enough to make it through the rinse water and onto the wet fabrics transferred into the clothes dryer. A significant portion of the fragrance contained in the detergent does not adsorb onto the fabrics and instead is drained away and wasted in the washing machine. Consequently, in order to achieve high fragrance retention on the fabrics, a second product is added during either the rinse cycle of the washing process (a heavily scented liquid fabric softener for example), or more preferred, added directly to the dryer in the form of a fabric softener sheet (a dryer sheet).

A second limitation of these conventional detergent and softening products is that it is difficult for a detergent to deliver either an anti-static benefit or a softening benefit due to the incompatibility of the quaternary ammonium compounds, the chemical required for either of these benefits, and the anionic surfactants that are required in detergent compositions for good cleaning. While a number of recent new product introductions have claimed to deliver “2-in-1” detergent benefits (cleaning+anti-stat/softening), the level of conditioning performance achieved by these products has been so very low so as to not be perceivable by the consumer. Finally, when detergents are applied to substrates to make laundry detergent sheets, the sheets end up considerably tacky. This is due to the fact that the detergent formulations need to be highly water soluble to come back off the substrate and dissolve into the wash liquor, and these types of ingredients in these formulations tend to be either hydrates that are initially tacky and/or hygroscopic, wherein the sheet will become tacky rapidly upon exposure to air in storage.

There have been several approaches to avoid tackiness in a laundry detergent sheet article. In addition to the Jones '946 and Flesher '565 methods for sandwiching layers described above, another example is described in U.S. Pat. No. 5,202,045 issued on Apr. 13, 1993 to Lever Brothers, (Karpusiewicz. '045), that claims an “S-shaped detergent laminate”. This substrate is folded back on itself, wherein the folded layers are literally adhered together with the sticky detergent composition. In this manner, a sandwiched article is created that insulates the user from touching the sticky detergent in between the layers but it does not require the seeming together of outer edges of two sheets. Alternatively, intense drying has been used to improve the tackiness of a laundry detergent sheet, however, hygroscopic materials will continue to hydrate in storage and sheets that are initially dry may still have a tendency to become tacky over time.

Accordingly, laundry articles are required that are reasonably sized, non-tacky and efficient at cleaning as currently marketed laundry detergents, yet superior in antistatic and softening of fabrics and superior in delivery of substantive fragrance to the fabrics in the dryer. Also, there is a clear need for a better method of manufacturing such articles.

### SUMMARY OF THE INVENTION

The present invention provides a laundry cleaning and conditioning article and a method for making and using it that provides efficient cleaning in the washer and significant fragrance delivery and softening/anti-static benefits through to the dryer, beyond the capabilities, of current products and methods. As will be described in detail below, the retention of the fabric softener through the wash cycle and its effective release in the dryer has been shown to be more dependent on the type of substrate rather than the composition of the softener portion of the article. Also, due to the multi-zone construction and design of the article, the present invention provides unique benefits and flexibility in handling for the consumer.

In general, the present invention is a laundry article comprising a water-insoluble substrate onto which a minimum of two compositions is applied in “zones”. For example a water-insoluble substrate with one zone of fragrance and/or softener/anti-static composition, plus one detergent composition zone, arranged in geographical areas, or patterns or regions, (called “zones”), on the water-insoluble substrate. Optional perforations on the article allow the consumer to break apart the article along defined lines to customize the product for the specific laundering requirements, customizing the amounts and the formulas used for a particular laundry load. The method of manufacturing is preferably application of co-melted materials, including both the detergent composition and the softener/fragrance/antistatic composition as heated co-melts, onto the substrate. Although the detergent mixtures of the present invention may be applied to the substrate as liquids, slurries, or pastes that are subsequently dried, the preferred method of making tack-free articles is to apply a melt (i.e., a thermo-settable heated melt that has minimum water content) that seeps or absorbs in between the fibers of the substrate, cools and solidifies into what appear as waxy zones. Lastly, the utility of the molten detergent compositions go well beyond application to the substrates in that the molten detergent may be cast into molds and cooled into shapes, or cooled in bulk, extruded and cut, to make what are single-dose detergent shapes (also laundry articles within the present invention) that are similar in use to detergent tablets, but which are molded solids rather than compressed powders.

In one exemplary embodiment of the article of the present invention, a co-melted detergent composition comprised of anionic materials (e.g. sulfonates, sulfates, and the like, etc.), and nonionic materials (e.g. alcohol ethoxylates, amides, esters, polyether waxes, and the like, etc.), along with builders and chelants (e.g. sodium carbonate, borax and/or silicates, tetrasodium-EDTA, and the like, etc.) and various adjuncts, is applied molten and hot to a nonwoven fabric substrate in a geographically zoned area, and a heated laundry conditioner composition comprised of molten quaternary surfactant with or without adjuvant such as fatty alcohol and/or fragrance is also applied molten and hot in a separate geographical zone on the substrate, in order to form a multi-zone laundry article that cleans and conditions fabrics when used sequentially in the washing machine and clothes dryer.

### BRIEF DESCRIPTION OF THE DRAWINGS

FIGS. 1-8 represent various embodiments of the present invention comprising at least two discrete composition zones on a substrate.

FIGS. 9-19 represent various embodiments of the present invention comprising at least two discrete composition zones and a perforation transecting the article.

FIG. 20 represents one embodiment of the present invention having a more decorative arrangement of at least 2 discrete composition zones on a substrate.

FIG. 21 represents one embodiment of the present invention having a more decorative arrangement of at least two composition zones and a perforation to break the article into two smaller pieces.

FIGS. 22-23 represent additional embodiments of the present invention with a more decorative arrangement of at least 2 discrete composition zones on a substrate.

FIG. 24 represents one embodiment of the present invention with 2 discrete composition zones and a blank zone where the user may hold the article, or optionally a substrate with 3 discrete composition zones.

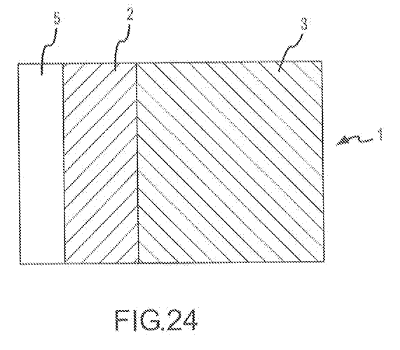

FIGS. 25-26 are bar graphs showing the percentage (%) of fabric softener lost from an article of the present invention through the wash and dry cycles for various nonwoven substrates.

FIG. 27 depicts a bar graph that shows the percentage (%) of fabric softener lost from an article of the present invention through the wash and dry cycles for one particular nonwoven substrate either left open, or folded and stapled with either the flat side in or the flat side out.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims. Additionally, though described herein in general terms of a laundry article comprised of laundry detergent and fabric conditioner compositions applied to a water-insoluble substrate, other cleansing and fabric treatment materials, such as bleaches, disinfectants, deodorants, stain treating chemicals, rust removers, water-conditioners and the like, applied or otherwise adsorbed onto the substrate either as part of the previously mentioned compositions or applied as separate zones on the substrate or treatments absorbed into the substrate, may likewise fall within the ambit of the present invention. Additionally any sort of non-functional additive to the compositions to product uniquely colored, textured, or agglomerated zones of detergent and softener compositions fall within the spirit of the invention. Furthermore, any particular physical shape and size for the substrate falls within the present invention along with any particular decorative or functional arrangement of the formula zones and direction and number of perforation's on the article. Lastly, any molded shape of the detergent compositions described herein constitute a laundry article of the present invention, including melt-cast detergent shapes that function as single-dose laundry detergent. Melt-cast detergents, independent of the substrate, may be either molded in small decorative molds (in processes resembling the commercial production of candies) or alternatively the molten hot detergent may be conveyed to a weir-box and dripped onto chill-belts, producing small pellets that may be boxed as an alternative to powdered detergents. A process for pelletized detergent is described in U.S. Pat. No. 4,931,202 to Diversey Corp., incorporated herein in its entirety, which may be adapted to pelletize the detergent compositions of the present invention.

That said, the present invention relates to an article of manufacture minimally comprising detergent and softener/anti-stat compositions on a water-insoluble substrate such as a nonwoven fabric, for use in the laundering process, first in the washer and subsequently along with the wet fabrics in the tumble dryer. In this manner, a single article can assist in cleaning and conditioning fabric and imparting a substantial and substantive fragrance, softening and anti-static behavior to the dried fabrics. The present invention further relates to methods for manufacturing such a laundry article.

More specifically, the present invention is an article of manufacture used for cleaning, softening, scenting and reducing the static of fabric in the sequential steps of washing and drying the fabric, comprising a water=insoluble substrate having zoned regions of detergent, conditioning; and optionally other fabric treatment compositions. The substrate and the fabric softening composition arc chosen such that the retention of the zone of fabric softening composition on the substrate through the wash cycle is at least about 80% and the release of the fabric softener in the dryer is at least about 70%. As will be described below, one unexpected result is that the release of the fabric softener composition in the dryer is strongly dependent on the nature of the substrate. Most surprisingly is that if the substrate is chosen wisely, the waxy fabric softener composition on the substrate need not have an added release/dispersant aid, such as a fatty alcohol as described in the prior art, to aid in the release of the softener from the substrate.

### The Substrate

In accordance with various embodiments of the present invention, a variety of materials may be used as the substrate in the present invention. For example the substrate may be natural pulp based paper or cotton materials, entirely synthetic material (such as melt-blow, spun-laid, air-laid or carded/bonded polypropylene, polyester, or similar synthetic polymer fiber substrates) or combinations of natural and synthetic materials (such as pulp wet-laid onto a nonwoven web). For example, any of the substrates used in the “wet-wipes” hard surface and personal cleansing products, dryer sheets, or personal hygiene products currently on the market may be useful as the substrates for the articles of the present invention. Additionally, materials that are found in liquid and air filtration industries may find use as the substrate. As will be discussed below, the selection of the substrate has been found to be critical to the performance of the product. The selection of the substrate affects a number of important performance variables in the laundry article. For example, the type of substrate affects; the amount (in grams for example) of detergent and softener loadable on the substrate, the percentage (%) of detergent that is delivered into the washer, the percentage (%) of softener retained on the substrate through the washer, the percentage (%) of softener delivered in the dryer, and lastly, the amount of lint observed on the fabrics at the end of the sequential wash and dry cycles.

Suitable substrate sheets may be obtained from any number of various water-insoluble nonwoven fabrics. The term “sheet” is used somewhat loosely here and relates to a preferred shape of an individual article of the present invention, that is, a flat sheet, for example square or rectangular, that is much greater in width and length than thickness and is a single laundry article. Thus the term “sheet” is used as a description of a section of nonwoven that may be used for an individual article of the present invention. However, the use of the term “sheet” should not be construed to limit the manufacturing process to a sequence of first cutting of substrate into small pieces (“sheets”) followed by application of the laundry compositions to these smaller individual sheets. The process may be just the reverse and there may be manufacturing economies to applying compositions to large rolls of substrate and then cutting those coated lengths into individual sheets or pieces.

Nonwoven fabrics with their multitude of uses are well known to those skilled in the textiles art. Nonwovens are described very thoroughly in “Nonwoven Fabrics: Raw Materials, Manufacture, Applications, Characteristics, Testing Processes”, editors W. Albrecht, H. Fuchs and W: Kittelmann, Wiley-VCH Verlag GmbH & Co. KgaA Weinheim, 2003. Such fabrics can be prepared by forming a web of continuous filament and/or staple fibers and optionally bonding the fibers at fiber-to-fiber contact points to provide fabrics of the required properties. The term “bonded nonwoven fabric” is used to include nonwoven fabrics where a major portion of the fiber-to-fiber bonding is achieved by either thermal fusion of adjacent fibers, or adhesive, bonding that is accomplished through incorporation of adhesives in the web to “glue” fibers together, or by other bonding such as obtained by the use of liquid or gaseous bonding agents (usually in conjunction with heating) to render the fibers cohesive. Chemical bonding may be accomplished through the use of adhesive or latex powders dispersed between the fibers in the web, which is then activated by heat, ultraviolet or infrared radiation, or other suitable activation method. Thermally and chemically bonded carded webs are described in U.S. Pat. No. 6,689,242 issued to First Quality Nonwovens, Inc, the subject matter of which is incorporated herein. Thermally and/or chemically bonded nonwovens may be used as the substrates within the present invention.

Nonwovens may comprise fibers known as “bi-component fibers”, for example “sheath/core bi-component fibers”, which are fibers having an outer sheath area or layer with a lower melting point than the inner core area, allowing for efficient and controlled thermal bonding through melting of just the outer layer of each fiber. That is, the outer surface of a bi-component fiber can be made to have a lower melting point than the core of the fiber. For example, binder bi-component fibers where one component has adhesive properties under bonding conditions are widely employed to provide integrity to fibrous webs used as absorbents in personal care products or in filtration products. Additionally, multi-component fibers are similarly known and commercially incorporated into nonwovens. Examples of such multi-component fibers are described in U.S. Pat. Nos. 5,382,400 and 5,866,488 and incorporated herein in their entirety.

During the bonding of the fibers, the web may be simultaneously subjected to mechanical compression to obtain the desired bonding, weights and thicknesses in a process known as “thermal compression bonding”. Thermal compression bonding may be accomplished by using apparatuses such as a hot embossing roll and a heat flat calendar roll, and incorporating a method in which a heat treating machine such as a hot blast-circulating type, a hot through-air type, an infrared heater type or a vertical hot blast-blowing type is used to carry out thermal compression bonding. Mechanical compression may be used to set the loft or thickness of fabrics with similar basis weights. Normally increasing the basis weight, or the mass per square area increases thickness, and increasing bonding and compression decreases loft. Nonwovens with “sidedness” are preferred for use in the articles of this invention. Sidedness refers to a nonwoven with a difference in density and/or loft on each side. These preferred nonwovens with sidedness may also be described by looking at the internal cross section through the nonwoven. For example, the preferred nonwovens for use herein have at least one “non-uniform cross-section”. That is, if the preferred nonwoven with sidedness is cut, the exposed edge will be seen to be inhomogeneous, or in other words, having a gradient of fiber densities from one side through to the opposite side of the nonwoven. Single or multiple passes of mechanical compression while bonding may be used to produce nonwoven fabric that has sidedness, for example by differing the heating for thermal bonding on each side, along with using differing fibers diameters for each side, and/or by thermal compression bonding a nonwoven that was carded with different groups of fiber types on each side. As described below, sidedness can also be accomplished by using different fiber thicknesses brought together in layers that look much like a laminating process, and allowing the heat/powder adhesive for thermal or powder/thermal bonding to bond the thinner more closely webbed fibers more densely and the than thicker less closely webbed fibers lighter and loftier. Laminated as a term used herein should be construed to mean fiber webs that were separately carded brought together to form a single nonwoven. The term laminated should not be construed to mean the gluing to together of layers of material such as gluing or otherwise bonding together a polyurethane scrubbing layer onto a cellulose sponge. Although nonowovens may be constructed by laminating together two or more carded webs of fibers, the net result is a thicker nonwoven wherein it is difficult to discern layers. Depending on how a multi-layered nonwoven is finished (for example, the degree of thermal or chemical/thermal bonding of the fibers), the net resulting laminated nonwoven may appear to be a single layer of fibers. But when looking at a cross section of such a preferred nonwoven, the gradient of density may be visible, even without discerning a discrete transition between the original carded webs.

Nonwoven webs have been formed from many processes, for example, melt-blown, spun-bonded or spun-laid, toe-opened, wet-laid, air-laid, carded, and high pressure hydro-entangled. The basis weight of non-woven webs is usually expressed in ounces of material per square yard (osy) or grams per square meter (gsm) and the fiber diameters are usually expressed in microns, or in the case of staple fibers, “denier”. “Denier” is defined as grams per 9000 meters of fiber length. For a fiber having circular cross-section, denier may be calculated as fiber diameter in microns squared, multiplied by the density in grams/cc, multiplied by 0.00707. Fiber denier can be measured according to ASTM D1907/D3218, incorporated herein by reference. A lower denier indicates a finer fiber and a higher denier indicates a thicker or heavier fiber. The “mean fiber denier” is the sum of the deniers for each fiber, divided by the number of fibers. A distribution of deniers, or an “average fiber denier” refers to a distribution of fiber diameters around a specific value, for example, “2 denier” refers to an average of 2 denier diameter fibers. As used herein, the term “bulk density” refers to the weight of a material per unit of volume and usually is expressed in units of mass per unit of bulk volume (e.g., grams per cubic centimeter). Nonwovens may be produced by fibers having a single average value of diameters or denier, or two or more average value diameter fibers may be used together. For example, two or more distributions of fiber deniers may be combined into separate fiber webs (2½ denier and 4 denier fibers carded together for example). Then separate fiber webs may be laminated together. The net result may be a single nonwoven with a non-uniform cross-section comprised of several different average fiber diameters. For example, a single nonwoven may comprise 2½, 4, 6, and 15 denier fibers, meaning it was constructed with four separate denier fibers (four separate average diameters of fibers).

“Basis weight” is a well known term in the art used to designate the weight of a nonwoven web per unit area of the web and are usually expressed in such units as “osy” (ounces per square yard; oz./sq.yd.), or “gsm” (grams per square meter, g/m² or gm⁻²), or “iv” (grams per square yard; g/yd²). As used herein, a “web” of fibrous material such as the nonwovens herein described is a sheet of thin, substantially contiguous fibrous material having two substantially parallel surfaces. Although a web of fibrous material need not be flat or smooth, theoretically, it is or can be laid out in a substantially planar, two-dimensional arrangement of indefinite length and indefinite width projecting in the two dimensions. The basis weight is determined based on a selected area defined by these two dimensions. The basis weight is determined by the weight of fibers laid down on a forming substrate per unit area, and is primarily a function of the fiber density, fiber denier and substrate speed relative to the apparatus used to lay down the fibers onto the substrate. In general, the basis weight increases with an increase in fiber density or fiber denier, or with a decrease in the substrate speed. The substrates used in the articles of the present invention may have a basis weight varying from about 2.0 to about 7.0 osy, preferably from about 3.0 to about 6.0 osy, and most preferably from about 3.5 to about 5.0 osy. The basis weight can be measured by ASTM D3776, incorporated herein by reference.

“Spun-bonded fibers” refers to fibers formed by extrusion of molten thermoplastic material as filaments, described for example in U.S. Pat. Nos. 4,340,563 to Appel; 3,692,618 to Dorschner; 3,802,817 to Matsuki; 3,338,992 and 3,341,394 to Kinney; 3,502,763 to Hartman; 3,542,615 to Dobo; and, 5,382,400 to Pike, the entire contents of each incorporated herein by reference. Spun-bond fibers are generally not tacky when they are deposited onto a collecting surface. Spun-bond fibers are generally continuous and have average diameter from about 7 microns to about 60 microns, and most often between about 15 and 25 microns.

“Melt-blown” refers to fibers formed by extruding molten thermoplastic material through a plurality of fine, normally circular, die capillaries as molten threads or filaments into converging high velocity, usually hot, gas/air streams that attenuate the filaments of molten thermoplastic material to reduce their diameter, which may end up to be clown to micro-fiber diameter. Thereafter the melt-blown fibers are carried by the high velocity gas stream and are deposited on a collecting surface to form a web of randomly dispersed meltdown fibers. Such a process is disclosed, for example, in U.S. Pat. No. 3,849,241. Melt-blown fibers are micro-fibers that may be continuous or discontinuous, and are generally smaller than 10 microns in average diameter, and are generally tacky when deposited onto a collecting surface.

“Air-laid” is a well-known process by which a fibrous non-woven layer can be formed. In the air-laid process, bundles of small fibers having typical lengths of from about 3 to about 52 millimeters (mm) are separated and entrained in an air supply and deposited onto a forming screen, usually with the assistance of a vacuum. The randomly deposited fibers then are bonded to one another using, for example, hot air to activate a binder component or latex adhesive. The air-laying process is taught in, for example, U.S. Pat. Nos. 4,640,810 to Laursen and 5,885,516 to Christensen.

A preferred nonwoven for use as the substrate for the articles of the present invention are carded thermal bonded, or carded powder/thermal bonded nonwovens, for example, those available from HDK Industries, Inc. Powder bonding is a dry process that starts with the carding of staple fibers to form a fibrous web, which is then treated with powdered thermal plastic adhesive or latex materials and subjected to a series of ovens and calendar rolls to produce the nonwoven. Additionally, heat can be used to loft a nonwoven after manufacturing, as a way to produce nonwovens with sidedness. The weight range of the bonded nonwovens for use in the present invention may be from about 2.0 osy to about 7.0 osy, preferably from about 3.0 osy to about 6.0 osy, and most preferably from about 3.5 to about 5.0 osy, with thicknesses ranging from about 50 mils to about 200 mils, preferably from about 75 to about 150 mils, and most preferably from about 85 to about 110 mils. The thickness of the substrates may be determined according to ASTM D1777, incorporated herein by reference. Where the surface-active composition contained in the articles of the present invention is a paste, gel, liquid, or viscous liquid form, the use of substrate materials having a thickness within the ranges described above will minimize the bleeding of the composition through the substrate, and maximize the effective delivery of the active materials in the washing and drying cycles of the laundering process.

The preferred fibers for the nonwovens of use in the present invention may be single, bi-component (e.g., sheath/core) or multi-component made from polypropylene, polyethylene, polyester, rayon, nylon, acrylic, modacrylic, polyethylene terephthalate, polybutylene terephthalate, polyamides, and mixtures of these types of polymers. The preferred deniers for the substrates used in the present invention are from about 0.9 to about 15. Preferred for use in the present invention are nonwovens comprised of a mixture of at least two different average diameters of polyester fibers that are carded and then thermally bonded (such as thermal compression bonding) or powder/thermal bonded. More preferred substrates for use in the present invention are 100% polyester nonwovens with weights ranging from about 2.0 to about 7.0 osy and which range from about 50-200 mils in thickness. The most preferred substrates are carded thermally bonded or carded powder/thermal bonded layered polyester nonwovens ranging from about 20 to about 90 g/yd² in weight and from about 75 to about 150 mils in thickness, further comprising both a flat side of carded fibers with at least one average denier of from about 1.5 to about 6, and a lofted side of carded fibers with at least one average denier of from about 3 to about 15. Such layered, multi-denier nonwovens with “sidedness” may be produced by single pass thermal compression bonding, or by two or more passes. These most preferred substrates necessarily have a “non-uniform cross-section” at least somewhere along the nonwoven. For example, the nonwoven may be uniform across its length and width (for example, viewing the top or the bottom surfaces of the substrate), yet still have non-uniform cross-section through its thickness (i.e., when viewing the edge of the substrate either as made or when cut through a cross-section). Additionally, nonwovens may be layered and in ways where the top layer does not fully cover the bottom layer and an asymmetrical fabric is produced that has part of its width as a single density fabric and an adjacent part of its width as a gradient of fiber densities. These nonwovens have a non-uniform cross-section somewhere on the fabric. For example, to see the non-uniform cross section one would have to cut the fabric in the area where there are two layers (and a gradient of density through the fabric thickness) rather than cutting through the single layer portion where there is uniform density of fibers through the thickness of the substrate. Any of these fibers used in the substrates may be single component polymers, bi-Component (sheath/core) or multi-component in order to get the desired level of fiber bonding in a thermal bonding operation. The most preferred nonwovens for use in the articles of the present invention, manufactured with these properties (widths up to 125 inches, basis weights of 0.3 osy to 3.5 osy, thicknesses from about 3 mils to 200 mils and a “non-uniform cross-section”, i.e. a gradient of fiber density through the thickness of the nonwoven), are available from HDK Industries, Inc. The most preferred substrates are carded thermally bonded or carded powder/thermal bonded layered nonwovens ranging from about 20 to about 90 g/yd² in weight and from about 75 to about 150 mils in thickness, further comprising both a flat side of carded fibers with at least two average deniers of from about 1.5 to about 6, and a lofted side of carded fibers with at least two average deniers of from about 3 to about 15. The most preferred substrates for use in the articles of the present invention are carded thermally bonded or carded powder/thermal bonded layered polyester nonwovens ranging from about 20 to about 90 g/yd² in weight and from about 75 to about 150 mils in thickness, comprising both a flat side derived from carded fibers with two deniers (combined 2½ and 4 denier), and a lofted side derived from carded fibers with at least two deniers (combined 4 and 6 denier, or combined 4, 6 and 15 denier). Some other types of multi-denier nonwoven fabric made from an interconnected network of thermoplastic polymer fibers and comprising a homogeneous blend of high denier staple fibers and low denier staple fibers are described in U.S. Pat. No. 6,087,551 to Pereira and incorporated herein.

Examples of nonwovens that may find use as the water-insoluble substrates to the articles of the present invention may include, but are not limited to, Ahlstrom Needlepunch, Ahlstrom 11B04.3110, Ahlstrom VPM7.1, Sandler Sawaloom® 6000, Sandler Sawaloom® 6600, Sandler Sawaloom® 6700, Sandler Sawaloom® 6351, Sandler Sawaloom®2621 and Sandler Sawatex® 2611 (spunlace products), all from Sandler AG; Texel® 04531 needlepunch, and Texel® 05232 needlepunch from Tenotex; and HDK #225 thermal bonded PET, and HDK #590, 401, 330, #2, #4 and #5 thermal bonded nonwovens from HDK Industries, Inc. The more preferred substrates include polyester nonwovens Comprised of at least two fiber deniers (thus having non-uniform cross section or a fiber density gradient through the thickness of the nonwoven), which are processed or layered in a method that produces a flatter more dense side and a lighter lofty side, and these include but not limited to the following materials available from HDK Industries, Inc.; a Flat/Lofty nonwoven comprised of 2½ and 4 denier fibers and 4 and 6 denier polyester and polyester bi-component fibers, 2-pass, layered, 4.2 osy and about 100 mils thick; a Flat/Lofty nonwoven comprised of 2-1/2 and 4 denier fibers and 4 and 6 denier polyester and polyester bi-component fibers, 1-pass, carded, layered, 4.2 osy and about 137 mils thick; Flat/Lofty nonwoven comprised of 2½ and 4 denier and 4 and 6 denier polyester and polyester bi-component fibers, 1-pass, carded, layered, 3.5 osy and about 107 mils thick; and, Flat/Lofty nonwoven comprised of 2½ and 4 denier and 4, 6 and 15 denier polyester and polyester bi-component fibers, 1-pass, carded, layered, 4.2 osy and about 128 mils thick. Less preferred are all lofty materials comprised of only a single layer of fiber web, for example comprised of 4 and 6 denier polyester and polyester bi-component fibers, 1-pass, non-sided, 4.2 osy and about 128 mils thick. Most preferred are layered polyester nonowovens having both a flat and lofty side, produced by single or two-pass thermal compression and/or powder/thermal bonding stages, and constructed from at least two average fiber deniers of polyester and/or polyester bi-component fibers having denier ranges of about 1.5 to about 6 denier fibers on the flat side and from about 3 to about 15 denier fibers on the lofty side. These most preferred substrate nonwovens are layered substrates. The fibers may be carded in layers, with the end result a gradient of fiber density and a gradient of fiber deniers. These preferred nonwovens have a non-uniform cross-section rather than visible layers such as for example a scrubbing sponge with cellulose and scrubbing layers. As described in more detail below, the combination of flat and lofty sides in the substrate greatly aids the loading and the subsequent release of the softener composition from the substrate. Not being bound by any theory, it appears that the softener feeds out from the flat side of the nonwoven substrate while in the heated clothes dryer, perhaps through wicking along a gradient of fiber deniers even though it was applied and solidified on the lofted side of the nonwoven. The delivery of softener through the flat side was shown by folding substrates in half, stapling them together with either the flat side hidden inside or exposed to the outside, and running them through the wash/dry cycles.

The nonwovens for the substrate in the article of the present invention have measurable “tensile strength.” Tensile strength is measurable in the “machine direction” (alternatively termed “MD” herein) and the “cross-machine direction” (alternatively termed “CD” herein). Machine direction is a well known term of art that is generally understood to refer to the direction corresponding to the length of the nonwoven as it is formed from conventional nonwoven forming apparatuses. The machine direction typically corresponds to the direction of fiber orientation as they are laid down to form the nonwoven. Cross machine direction refers to the direction which is 90° to the machine direction. The nonwoven is substantially formed in a plane defined by the machine and cross-machine directions.

The terms “MD tensile strength” and “CD tensile strength,” as used herein, has reference primarily to peak lad values in MD or CD orientation according to ASTM D629, incorporated herein by reference. Preferred substrates used in the articles of the present invention may have a MD tensile strength of from about 10.0 to about 35.0 lbs./in., preferably from about 15.0 to about 30.0 lbs./in., and most preferably from about 17.0 to about 28.0 lbs./in. The substrates used in the articles of the present invention may have a CD tensile strength of from about 2.0 to about 8.0 lbs./in., preferably from about 3.0 to about 6.5 lbs./in., and most preferably from about 3.5 to about 6.0 lbs./in.

The nonwovens for the substrate in the article of the present invention also have measurable “air permeability.” It is preferred that both substrate layers have air permeabilities of at least about 50 cubic feet per minute per sq. ft. It is preferred that the substrate used has an air, permeability of at least about 79 cubic ft. per minute per sq. ft. and less than about 700 cubic ft. per minute per sq. ft., more preferably about 150 cubic ft. per minute per sq. ft. and less than about 600 cubic ft. per minute per sq. ft., and most preferably about 300 cubic ft. per minute per sq. ft. and less than about 500 cubic ft. per minute per sq. ft. The air permeabilities of the substrate materials may be determined according to ASTM D737 incorporated herein by reference.

The dimensions of the sheet cut for the substrate in the article of the present invention should be suitable for easy handling, for example in the range of from about 4 inches×4 inches to about 8 inches×8 inches, however sheets of other dimensions may be useful when organized in convenient packaging for the consumer. Of course the sheet does not need to be square or really any particular shape, and any shape such as rectangular, polyhedral, rhomboidal, round, oval, heart- or other decorative-shape, even shaped in a way to identify a particular brand (such as the shape of a letter or word or trademark), will work within the present invention. The substrate for use in the present invention may be colored in any color (vivid colors for example), or may be substantially white, and may be textured from heated rollers that are patterned. The sheets may be rolled up or folded or otherwise intricately compacted in order to fit some unique packaging designs, or may be simply stacked like stiff cards into a suitable carton for merchandising. Also, the aesthetics of the sheet should be pleasing enough so that consumers will want to use it with their laundry chores. Thus, each of the separate composition zones should be individually recognizable to the consumer, for example through color, transparency, gloss, texture, fragrance, or any combinations of these attributes. For example, a sheet within the present invention may have a deep blue detergent zone and an opaque pink softener/antistatic zone (knowing that these are consumer recognizable and traditional detergent and fabric softener colors), or perhaps a detergent region that has colored particles embedded within the zone. A wider and flatter sheet treated with a substantial amount of molten/solidified detergent and softener compositions may be brittle looking and somewhat stiff, and these flatter stiffer sheets may be more suitably packaged in stacks and more amenable to perforations for the consumer to break them apart to customize their use. Smaller and thicker articles may provide easier handling in cases where perforation is not utilized. Depending on the loft of the substrate and its absorptive capacity, the article of the present invention may have considerable loading of detergent and softener composition even though the article appears relatively small in dimension.

The water-insoluble substrate for the laundry article of the present invention may be impregnated with detergent and conditioning compositions through any suitable processing step, for example a simple spray coating of the nonwoven substrate with a heated molten mixture or an aqueous solution to even dipping of the nonwoven substrate into various mixtures. For example, the molten compositions may be sputter-sprayed from guns with heated nozzles much in the same way that heavy paints, glues and coatings and the like are sprayed onto wide surfaces in many other industries. The impregnation of each composition on the substrate may be conducted either at the same time (in a simultaneous process with parallel feeders or sprayers for example) or in separate operations that are perhaps sequential operations of the same process or separate combinations of different processes. Impregnations may be applied on one side of the substrate, or one or more impregnations (for example the detergent formulation) can be applied on one side, and the other composition (for example the conditioner/fragrance/anti-static formulation) may be applied on the other side of the substrate. This is a particularly important option for when a substrate having dissimilar sides is used. A suitable process for impregnation is for example a slot-coating process or a Gravure-coating process. In a slot coating process, the fluid to be coated is forced under pressure through a thin slot of a given width and length. The mass rate of application (gm/second) is controlled by both application pressure and slot size. The substrate (e.g., nonwoven or otherwise) is coated as it is drawn past the slot (for example at 1-100 feet per minute). Depending upon the scale of manufacture, representative slot-coating dies include Ultracoat, Acuflow, Ultra flow product from Extrusion Dies Industries LLC (EDI), Wayne Yellow Jacket® Flexible Lip Flat Dies, or Liberty Die Coating Equipment. The form of any of the compositions applied to the substrate may be anything from thin to thick liquid, to slurry or paste, to molten materials that solidify into waxy appearing coatings upon cooling. It is simpler and preferable to apply both the detergent and the softener compositions as molten mixtures, even though the detergent compositions may be applied as aqueous solutions or slurries in a spray or dipping operation with a subsequent drying step to remove the excess water from the substrate. In the most preferred embodiment of the present invention the softener composition is applied molten and absorbed into the lofty side of a two sided (Flat/Lofty) polyester nonwoven such as those described above. It should be understood that the scope of the present invention includes the application of any of the described compositions in stages to the substrate. For example, in the application of a detergent composition to the substrate, one or more of the ingredients may be left out of the composition and applied separately to the nonwoven (for example, to pre-condition the substrate). Then the remaining ingredients comprising the detergent composition are applied to the substrate. Additionally it is within the scope of the present invention to separate out a “third zone” on the substrate. For example, it may be desirable to have a detergent zone, a fabric softener zone and a third, separate fabric treatment zone, such as a water-soluble builder or water condition, an extra surfactant or detergent booster, or a separate water-soluble fabric softener for the washing cycle, or a separate fragrance boost zone for the washer or dryer, and so, forth. The invention is not restricted to just a detergent zone and a fabric conditioner zone. Special products for separate market needs may be produced that have any number of zoned compositions or ingredients as suits the market/consumer needs.

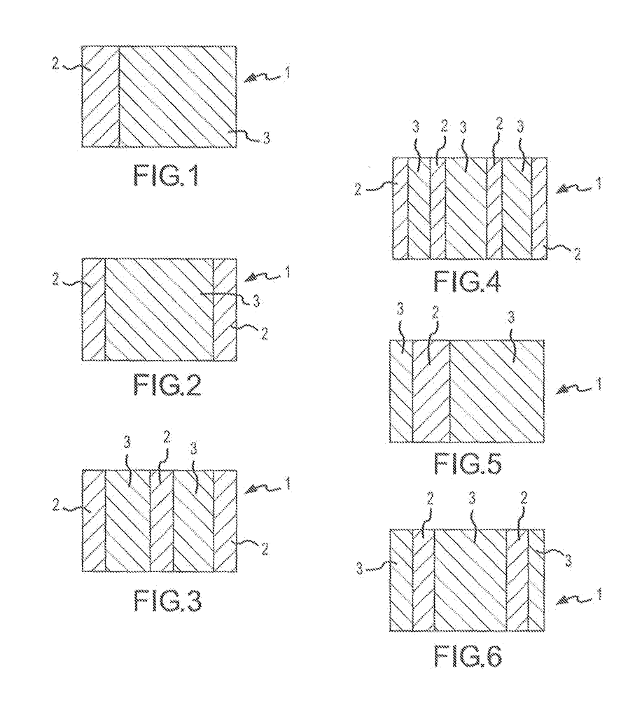

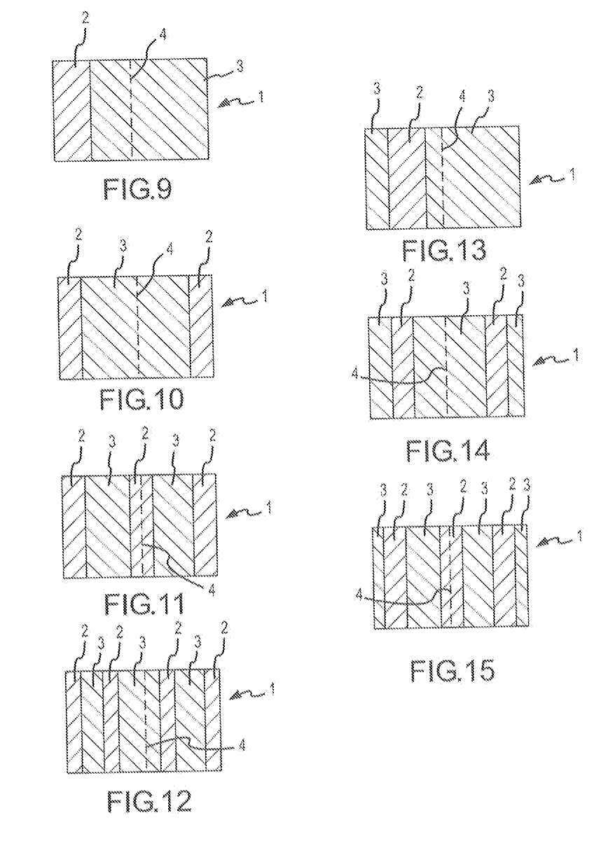

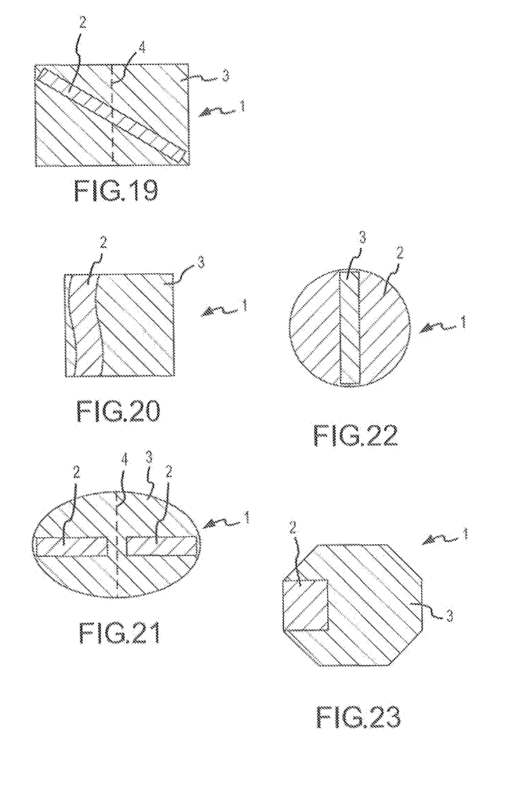

Shown in the drawing figures are several different ways to arrange the detergent; softener and additional composition zones on the substrate. For example, FIGS. 1-8 depict various arrangements of separate composition zones 2 and 3 on the substrate to produce laundry article 1. Although FIGS. 1-8 show multiple zones, it should be understood that the zones do not need to be limited to only detergent and softener zones. The zones shown in these drawing figures may be combinations of detergent, softener or other fabric treatment compositions. FIGS. 20 and 22-23 show more decorative arrangements of the composition zones on the substrate to produce laundry articles that are more interesting in appearance for the consumer. As mentioned earlier, the articles may be cut in recognizable shapes such as the shape of the letters spelling out a brand name, or in the shape of a trademark, etc. FIG. 22 shows a circular article and FIG. 23 shows an octagonal article, but the number of embodiments of shapes and sizes and number of fabric treatment zones is virtually endless and these drawings are meant to illustrate only a few of endless examples.

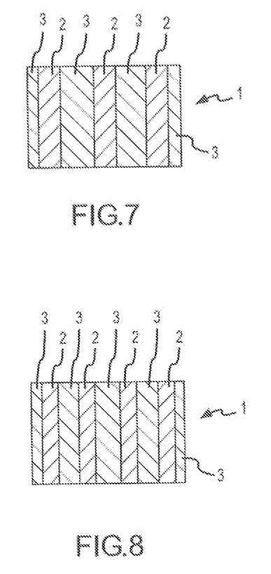

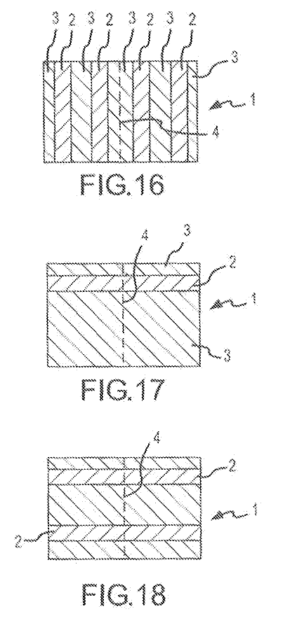

The laundry article, with its multiple compositions arranged in zones around the substrate, may have one or more perforations so that it can be divided into two or more equal or unequal parts. The perforation(s) may be through the symmetry axis (as shown by perforation 4 in FIGS. 10, 14, 15, and 16) so that two separate sheets with either multi-zone fabric treatment compositions or single zone fabric treatment compositions result. As shown in FIGS. 9, 12 and 13, the perforation 4 may run through the article such that breaking the article across the perforation gives pieces with different compositions, (for example, a half with only detergent composition and a second half with both detergent and fabric softener compositions, etc.). Alternatively, the one or more perforations 4 may transect all of the fabric treatment composition zones such that breaking the overall sheet into smaller portions along the perforations merely makes smaller sheets of the same compositions for smaller laundry loads (as shown in FIGS. 17, 18, 19 and 21). The perforations may already be on the substrate before coating or may be added after applying the compositions to the substrates. Or, the articles may be individual cut from larger rolls of nonwoven and perforates at the same time. The perforations may enhance interaction with the product by allowing the consumer to tear out decorative elements along perforations, for example a laundry article in letters that spell out a brand name and the consumer able to break off various letters from the name. The removed sections of the product may be used for other tasks around the home. For example, a removed section 3 such as shown in FIG. 9 with only detergent composition may be placed into a mop bucket to use as a hard surface cleaner around the home. Sections of fabric softener/fragrance may be saved and used in a separate dryer cycle at a later date in the same way as a conventional “dryer sheet”, or even used as an air freshener for example, placed under the seat in an automobile or wedged into a heating/cooling register in the home. FIGS. 9-19 and 21 show perforated articles that are meant to just highlight the enormous possibilities rather than to imply any limitation. The articles of the present invention can have limitless arrangement of detergent, fabric conditioning and other fabric treatment zones and limitless arrangements of the one or more perforations.

Embodiments within the present invention may include, but are not limited to: sheet-like articles with at least two composition zones where at least one zone is processed using slot-coating equipment at elevated temperature; sheet-like articles with at least two composition zones where one zone is completely soluble in water while the second zone is more than 80% retained (stable) through a standard wash cycle; sheet-like articles with at least two composition zones where one zone has a high wetting/water uptake tendency while the second zone has a lower wetting/water uptake tendency; sheet-like article with at least two composition zones where one zone has a melting point of >58 C; sheet-like article with at least two composition zones where at least one zone can be applied by slot coating; sheet-like article with at least two composition zones where both zones are significantly absorbed into the substrate material leaving only a minor exposed surface of composition; sheet-like article with at least two composition zones that shows only minor physical shrinkage in the washing and drying application and that releases active ingredients in both the washing and drying steps of laundering; sheet-like article with at least two composition zones where one zone geographically covers 2-30% of the total surface area of the article while the second zone covers 70-98% of the total surface area of the article; sheet-like article with at least two composition zones where at least one zone has a tack-free feeling if touched with hands; sheet-like article with at least two composition zones where one zone is present at the level of 0.5-10 g while the second zone is present at the level of 5-25 g on the substrate; laundry sheet articles of manufacture that deliver high, substantive levels of fabric softener, fragrance and anti-stat in the dryer, even though the article was first run through the washing cycle to deliver detergent; laundry sheet articles made by applying hot, melted and nearly anhydrous detergent/builder compositions and quaternary ammonium fabric softener/fatty alcohol compositions in separate zones on a substrate.

### Detergent and Conditioner Compositions for Application to the Substrate

The detergent composition applied to the substrate may comprise anionic, nonionic, builder, chelant and adjuvant ingredients and is preferably a co-melt of mostly anhydrous waxy ingredients (materials normally solids or waxes at ambient temperature), or low-water content slurry or paste. The detergent composition even if a co-melt of waxy ingredients may preferably contain insoluble particles agglomerated into the melt, either for performance or aesthetic reasons.

The anionic material for use in the detergent composition is preferably anionic surfactants such as the sulfonate type and of the sulfate type. Preferred surfactants of the sulfonate type are C₉₋₁₃ alkylbenzenesulfonates, olefinsulfonates, i.e. mixtures of alkenesulfonates and hydroxyalkanesulfonates and also disulfonates, as are obtained, for example, from C₁₂₋₁₈-monoolefins having a terminal or internal double bond by sulfonating with gaseous sulfur trioxide followed by alkaline or acidic hydrolysis of the sulfonation products. Anionic surfactants that may find use in the compositions of the present invention include the alkyl benzene sulfonate salts. Suitable alkyl benzene sulfonates include the sodium, potassium, ammonium, lower alkyl ammonium and lower alkanol ammonium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft®LPS-99 or Calsoft®TSA-99 marketed by the Pilot Chemical Company. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Most preferred is the nearly anhydrous flaked sodium dodecylbenzene sulfonate such as Calsoft® F-90. Also of use in the present invention are the ammonium salts, lower alkyl ammonium salts and the lower alkanol ammonium salts of linear alkyl benzene sulfonic acid, such as triethanol ammonium linear alkyl benzene sulfonate including Calsoft® T-60 marketed by the Pilot Chemical Company. The preferred level of sulfonate surfactant in the present invention is from about 1.0% to about 50%. Most preferred is to use sodium dodecylbenzene sulfonate 91% flake at a level of from about 3% to about 40%.

Also with respect to the anionic surfactants useful in the detergent composition applied to the substrate, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 9 mol of ethylene oxide (x=0.5 to 9 EO), such as C₁₂-C₁₈ alcohols containing from 0.5 to 9 EO, and where M is alkali metal or ammonium, alkyl ammonium or alkanol ammonium counterion. Preferred alkyl ether sulfates for use in one embodiment of the present invention are C₈-C₁₈ alcohol ether sulfates with a degree of ethoxylation of from about 0.5 to about 9 ethylene oxide moieties and most preferred are the C₁₂-C₁₅ alcohol ether sulfates with ethoxylation from about 4 to about 9 ethylene oxide moieties, with 7 ethylene oxide moieties being most preferred. It is understood that when referring, to alkyl ether sulfates, these substances are already salts (hence “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 3 ethylene oxide moieties) is very readily available commercially and quite common in shampoos and detergents, however, this is not the preferred level of ethoxylation for use in the present invention. Therefore it may be more practical to sulfonate a commercially available nonionic surfactant such as Neodol® 25-7 Primary Alcohol Ethoxylate (a C₁₂-Cᵢₛ/7EO nonionic from Shell) to obtain the C₁₂-C₁₃/7EO alkyl ether sulfate that may have been more difficult to source commercially. The preferred level of C₁₂-C₁₈/0.5-9EO alkyl ether sulfate in the present invention is from about 1% to about 50%. Most preferred is from about 3% to about 40%.

Other anionic surfactants that may be used in the detergent composition include the alkyl sulfates, also known as alcohol sulfates. These surfactants have the general formula R—O—SO₃Na where R is from about 10 to 18 carbon atoms, and these materials may also be denoted as sulfuric monoesters of C₁₀-C₁₈ alcohols, examples being sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detergents standpoint, C₁₂-C₁₆-alkyl sulfates and C₁₂-C₁₅-alkyl sulfates, and also C₁₄-C₁₅ alkyl sulfates, are preferred. In addition, 2,3-alkyl sulfates, which may for example be obtained as commercial products from Shell Oil Company under the brand name DAN®, are suitable anionic surfactants. Most preferred is to use 97% powdered sodium lauryl sulfate from the Stepan Company, recognized under the trade name of Polystep® B-3. The preferred level of alcohol sulfate in the present invention is from about 1% to about 50%. Most preferred is from about 3% to about 40%.

Fatty soaps may also be incorporated into the detergent composition as an anionic detergent component. As used here, “fatty soap” means the salts of fatty acids. For example, the fatty soaps that may be used here have general formula R—CO₂M, wherein R represents a linear or branched alkyl or alkenyl group having between about 8 and 24 carbons and M represents an alkali metal such as sodium or potassium or ammonium or alkyl- or dialkyl- or trialkyl-ammonium or alkanolammonium cation. The fatty acid soap, which is a desirable component having suds reducing effect in the washer, (and especially advantageous for side loading or horizontal tub laundry machines), is preferably comprised of higher fatty acid soaps. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids of particular use in the present invention arc linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are alkali metal salts, such as sodium and potassium or mixtures thereof. Other useful soaps are ammonium and alkanol ammonium salts of fatty acids. The fatty acids that may be included in the present compositions will preferably be chosen to have desirable detergency and effective suds reducing effect. Of course, for compositions wherein foaming is desirable soap content is omitted or lowered or a lower fatty acid soap, e.g.; sodium laurate, may be used instead, but this is not the preferred strategy for the compositions of the present invention where suds suppression is desired. The preferred level of fatty soap in the present invention is from about 1% to about 50%. Most preferred is from about 3% to about 40%.

Additional anionic materials that may be included in the detergent composition include, the salts of alkylsulfosuccinic acid, which are also referred to as sulfosuccinates or as sulfosuccinic esters and which constitute the monoesters and/or diesters of sulfosuccinic acid with alcohols, preferably fatty alcohols and especially ethoxylated fatty alcohols. Preferred sulfosuccinates comprise C₈-C₁₈ fatty alcohol radicals or mixtures thereof. Especially preferred sulfosuecinates contain a fatty alcohol radical derived from ethoxylated fatty alcohols which themselves represent nonionic surfactants. Particular preference is given in turn to sulfosuccinates whose fatty alcohol radicals are derived from ethoxylated fatty alcohols having a narrowed homolog distribution. The anionic sulfosuccinate surfactant may be present in the composition in a range from about 1% to about 50% by weight of the composition, more preferably 3% to 40% by weight of composition.

The detergent compositions for application to the substrates of the present invention may also include one or more nonionic materials such as nonionic surfactants, fatty alcohols, esters, amides, polyols, polypropylene or polyethylene glycols, waxes and the like. For example, the compositions may include nonionic surfactants such as the ethoxylated and/or propoxylated primary alcohols having 10 to 18 carbon atoms and on average from 4 to 12 mol of ethylene oxide (EO) and/or from 1 to 10 mol of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Most useful as a nonionic surfactant in the present invention is the C₁₄-C₁₅ alcohol ethoxylate-7EO, mentioned above as a useful precursor to the corresponding sulfate, and the C₁₂-C₁₄ alcohol ethoxylate-12EO incorporated from about 1% to about 50%, and most preferably used at a level of from about 1% to about 20%. Preferred nonionic surfactants for use in this invention include for example, Neodol® 45-7, Neodol® 25-9, or Neodol® 25-12 from Shell Chemical Company. Most preferred are Neodol® 45-7, which is a C₁₄-C₁₅ alcohol ethoxylate-7EO and Surfonic® L24-12, available from Huntsman, which is a C₁₂-C₁₄ alcohol ethoxylate-12EO surfactant (or the Neodol® 25-12 from Shell which is the petroleum feedstock derived material that is substantially similar in performance). Combinations of more than one alcohol ethoxylate surfactant may also be desired in the detergent composition in order to maximize cleaning performance in the washing machine and to minimize tackiness or the solidified composition on the substrate.

The detergent composition for application to the substrate may also include an amide type nonionic surfactants, for example alkanolamides that are condensates of fatty acids with alkanolamines such as monoethanolamine (MEA), diethanolamine (DEA) and monoisopropanolamine (MIPA), that have found widespread use in cosmetic, personal care, household and industrial formulations. Useful alkanolamides include ethanolamides and/or isopropanolamides such as monoethanolamides, diethanolamides and isopropanolamides in which the fatty acid acyl radical typically contains from 8 to 18 carbon atoms. Such dialkanolamides are typically liquid, while monoalkanolamides are solids having melting points of 40° C. to about 90° C., which is why the monoethanolamides are especially preferred in this invention since they can be co-melted with the other detergent ingredients. Especially satisfactory alkanolamides have been mono- and diethanolamides such as those derived from coconut oil mixed fatty acids or special fractions containing, for instance, predominately C₁₂ to C₁₄ fatty acids. For most applications, alkanolamides prepared from trialkylglycerides are considered most practical due to lower cost, ease of manufacturing and acceptable quality. Of particular use in this invention are mono- and diethanolamides derived from coconut oil mixed fatty acids, (predominately C₁₂ to C₁₄ fatty acids), such as those available from McIntyre Group Limited under the brand name Mackamide®. Most preferred for incorporation into the detergent compositions of the present invention is Mackamide® CMA, which is coconut monoethanolamidc available from McIntyre. Amide surfactants when used in these detergent compositions are preferably incorporated at a level of 1-50% and most preferably from 3% to about 40%.

Additional nonionic surfactants that may find use in the compositions of the present invention include the alpha-sulfonated alkyl esters of C₁₂-C₁₆ fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO₃. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C₆-C₂₂ carboxylic acids that are sulfonated with gaseous SO₃ as described in the “The Journal of American Oil Chemists Society,” 52 (1975), pp. 323-329. Suitable starting materials preferably include natural fatty substances as derived from tallow, palm oil, etc., rather than petroleum derived materials. The preferred alkyl ester sulfonate surfactants, especially for a detergent composition for the present invention, comprise alkyl ester sulfonate surfactants of the structural formula R³—CH(SO₃M)-CO₂R⁴, wherein R³ is a C₈-C₂₀ hydrocarbon chain preferably naturally derived, R⁴ is a straight or branched chain C₁-C₆ alkyl group and M is a cation which forms a water soluble salt with the alkyl ester sulfonate, including sodium, potassium, magnesium, and ammonium cations. Preferably, R³ is: C₁₀-C₁₄ fatty alkyl, and R⁴ is methyl or ethyl. Most preferred are alpha-sulfonated methyl or ethyl esters of a distribution of fatty acids having an average of from 12 to 16 carbon atoms. For example, the alpha-sulfonated esters Alpha-Step® BBS-45, Alpha-Step® MC-48, and Alpha-Step PC-48, all available from the Stepan Co. of Northfield, Ill., may find use in the present invention. Alpha-sulfonated fatty acid ester surfactants may be used at a level of from about 0.1-50% and most preferably at a level of from about 3% to about 40% by weight in the detergent composition.

The detergent composition applied to the substrate may also include an alkyl polyglycoside surfactant. The alkyl polyglycosides (APGs), also called alkyl polyglucosides if the saccharide moiety is glucose, are naturally derived, nonionic surfactants. The alkyl polyglycosides that may be used in the present invention are fatty ester derivatives of saccharides or polysaccharides that are formed when a carbohydrate is reacted under acidic condition with a fatty alcohol through condensation polymerization. The APGs are typically derived from corn-based carbohydrates and fatty alcohols from natural oils in animals, coconuts and palm kernels. Such methods for deriving APGs are well known in the art, for example U.S. Pat. Nos. 5,003,057 and 5,003,057 relating the methods of making APGs and the chemical properties of APGs is incorporated herein by reference. The alkyl polyglycosides that are preferred for use in the present invention contain a hydrophilic group derived from carbohydrates and is composed of one or more anhydroglucose units. Each of the glucose units can have two ether oxygen atoms and three hydroxyl groups, along with a terminal hydroxyl group, which together impart water solubility to the glycoside. The presence of the alkyl carbon chain leads to the hydrophobic tail to the molecule.

When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of varying concentration of glucose units (or degree of polymerization).

The APGs that may be used in the detergent composition preferably comprise saccharidc or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APGs, x may be a noninteger on an average basis when referred to APG used as an ingredient for the detergent composition of the present invention. For the APGs of use in the compositions of the present invention, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred for use in the present compositions are APGs with an average degree of polymerization of from 1.4 to 1.7 and the chain lengths of the aliphatic groups are between C₈and C₁₆. For example, one preferred APG for use herein has chain length of C₈ and C₁₀ (ratio of 45:55) and a degree of polymerization of 1.7. The detergent compositions of the present invention have the advantage of having less adverse impact on the environment than conventional detergent compositions. Alkyl polyglycosides used in the present invention exhibit low oral and dermal toxicity and irritation on mammalian tissues. These alkyl polyglycosides are also biodegradable in both anaerobic and aerobic conditions and they exhibit low toxicity to plants, thus improving the environmental compatibility of the rinse aid of the present invention. Because of the carbohydrate property and the excellent water solubility characteristics, alkyl polyglycosides are compatible in high caustic and builder formulations. The detergent composition preferably includes a sufficient amount of alkyl polyglycoside surfactant in an amount that provides a desired level of cleaning on fabrics. Preferably, the detergent composition concentrate includes between about 1% and about 50% by weight alkyl polyglycoside surfactant and more preferably between 3 and 40% alkyl polyglycoside surfactant.

Additional classes of nonionic surfactants that may be used in the detergent composition include alkoxylated, preferably ethoxylated or ethoxylated/propoxylated, fatty acid alkyl esters, preferably having 1 to 4 carbon atoms in the alkyl chain, especially fatty acid methyl esters. Further suitable surfactants include those known as “gemini surfactants”. This term is used generally to refer to those compounds that possess two hydrophilic and two hydrophobic groups per molecule. These groups are generally separated from one another by what is known as a spacer. This spacer is generally a carbon chain, which should be long enough to keep the hydrophilic groups at a distance sufficient to allow them to act independently of one another. Surfactants of this kind are generally notable for an unusually low critical micelle concentration and the ability to reduce greatly the surface tension of water. In exceptional cases, however, the expression gemini surfactants is used to embrace not only dimeric but also trimeric surfactants. Examples of suitable gemini surfactants are sulfated hydroxy mixed ethers in accordance with German patent application DE-A-43,21,022 or dimer alcohol bis- and trimer alcohol tris-sulfates and ether sulfates in accordance with international patent application WO-A-96/23768. Tipped dimeric and trimeric mixed ethers in accordance with German patent application DE-A-195,13,391 are notable in particular for their bi- and multi-functionality. These capped surfactants possess good wetting properties and are low-suds, making them particularly suitable for use in machine washing or cleaning processes. However, it is also possible to use gemini-polyhydroxy fatty acid amides or polypolyhydroxy fatty acid amides, as described in international patent applications WO-A-95/19953, WO-A-95/19954, and WO-A-95/19955. The polyhydroxy fatty acid amides are known materials, typically obtainable by reduction amination of a reducing sugar with ammonia, an alkylamine or an alkanolamine and subsequent acylation with a fatty acid, a fatty acid alkyl ester or a fatty acid chloride.

Capped alkoxylated fatty amines and fatty alcohols may also be advantageous in the detergent composition, especially for use in the present invention's nonaqueous detergent compositions. In capped fatty alcohol alkoxylates and fatty amine alkoxylates, the terminal hydroxyl groups of the fatty alcohol alkoxylates and fatty amine alkoxylates are etherified with C₁-C₂₀-alkyl groups, preferably methyl or ethyl groups.

The detergent composition applied to the substrate may also include polyether materials, such as a polyethylene or polypropylene glycol, or mixtures of these. One such polyether useful in the composition is a polyethylene glycol (or “PEG”). The preferred polyethylene glycol has a molecular weight great enough that the material is a solid at ambient temperature. Therefore the preferred molecular weight range is from about 950 to about 10,000 g/mole. These materials are most readily obtained from the Dow Chemical Company under the brand name Carbowax®. The most preferred polyethylene glycol for use in the present invention are the PEGs having molecular weight from about 950 to about 4,000. The most preferred materials are Carbowax® 1450, Carbowax® 3350 and Carbowax® 4000, available from Union Carbide, which are PEG-32, PEG-75 and PEG-90, respectively. The useful range of use is to incorporate the PEG into the composition at from about 0.1% to about 10% by weight, and most preferred is from about 0.5% to about 5%.

Additional nonionic polyether material's that may find use in the detergent composition are, polyethers such as polyoxyethylene cetyl ethers, polyoxyethylene oleyl ethers, polyoxyethylene stearyl ethers, polyoxyethylene lauryl ethers, polyoxyethylene isocetyl ethers, polyoxyethylene isostearyl ethers, polyoxyethylene octydodecyl ethers, polyoxyethylene behenyl ethers, polyoxyethylene decyltetradecyl ethers, polyoxyethylene chloesteryl ethers, polyoxyethylene polyoxypropylene ethers. Also the ester type products including fatty acid esters, sorbitan fatty acid esters, fatty acid monoglycerides, fatty acid triglycerides, propylene glycol fatty acid esters, ethylene glycol fatty acid esters, and the like. Also, the ether-ester type emulsifiers may find use here as well, including such nonionic materials as polyethyleneglycol monostearates, polyethyleneglycol monooleates, polyethyleneglycol monolaurate, polyoxyethylene hydrogenated castor oils, polyoxyethylene glyceryl monostearates, polyethyleneglycol monoisostearates, polyoxyethylene castor oils, polyoxyethylene cetyl ether stearates, polyoxyethylene stearyl ether stearates, polyoxyethylene cetyl ether stearates, polyoxyethylene lauryl ether isostearates, polyethyleneglycol dilaurates, polyethyleneglycol distearates, polyethyleneglycol diisostearates, polyethyleneglycol dioleates, polyethylene sorbitan fatty acid esters, and polyethylene sorbitan fatty acid esters, and the like. A preferred matrix forming material for use here is polyethylene (100) stearyl ether, C₁₈H₃₇(OCH₂CH₂)ₙOH, where n is an average of 100, which is obtainable from Uniqema as Brij® 700 or from Rhodia as Rhodasurf® TB-970.

The detergent composition applied to the substrate of the present invention may also include a builder. Such builders may include but are not limited to carbonates, bicarbonates, silicates, borates, zeolites, phosphates, citrates, alkali metal hydroxides, and the like. Water conditioning agents may also be part of the present invention and may include but are not limited to EDTA, the various mono-, di-, tri- and tetra-sodium salts of EDTA, NTA (nitrilotriacetic acid) and its various alkali metal salts, and phosphates such as sodium tripolyphosphate and the like.

The silicate builder may be a combination of liquid silicate and anhydrous silicate in order to help minimize the amount of water in the detergent composition, (to reduce tackiness and to improve dry time after application of the detergent co-melt). The composition may contain one or more silicate substances to help whiteness maintenance. The preferred silicate is an alkali metal silicate salt (the alkali metal salts: of silicic acid) with the sodium and potassium silicate salts being the most preferred. The alkali metal silicates that are useful may be in a variety of forms that can be described by the general formula M₂O:SiO₂, wherein M represents the alkali metal and in which the ratio of the two oxides varies. Most useful alkali metal silicates will have a SiO₂/M₂O weight ratio of from about 1.6 to about 4. These silicates provide alkalinity to the composition (and to the resulting laundry wash liquor) and this alkalinity is far in excess of what is required to neutralize the small amounts of added fatty acids in the compositions to their corresponding alkali metal salts (soaps). Preferred silicates include the Sodium Silicate Solutions from PQ Corporation, such as A®1647 Sodium Silicate Solution, a 46.8% active solution of sodium silicate having a SiO₂/Na₂O ratio of about 1.6 to about 1.8:1. Also of use in the compositions of the present invention are the potassium silicates, such as the Kasil® products from PQ Corporation. For example, Kasil® 1 Potassium Silicate Solution is of use in the present invention and is a 29.1% solution of potassium silicate having a SiO₂/K₂O ratio of about 2.5. It is preferable to use either sodium or potassium silicate at a level of from about 0.5% to about 5% in the compositions of the present invention. Also of use is sodium metasilicate and sodium silicate, such as the hydrous sodium silicate Britesil® C24 available from PQ Corporation. It is preferred to incorporate the builder at from about 0.5% to about 25%.

The detergent composition zone may also include a water-soluble polymer such as a polycarboxylate. Particularly suitable polymeric polycarboxylates are derived from acrylic acid, and this polymer and the corresponding neutralized forms include and are commonly referred to as polyacrylic acid, 2-propenoic acid homopolymer or acrylic acid polymer; and sodium polyacrylate, 2-propenoic acid homopolymer sodium salt, acrylic acid polymer sodium salt, poly sodium acrylate, or polyacrylic acid sodium salt. Preferred in the compositions of the present invention is sodium polyacrylate with average molecular weight from about 2,000 to 10,000, more preferably from about 4,000 to 7,000 and most preferably from about 4,000 to 5,000. Soluble polymers of this type are known materials, for example the sodium polyacrylates and polyacrylic acids from Rohm and Haas marketed under the trade name Acusol®. Of particular use in the present invention is the average 4500 molecular weight sodium polyacrylate, (for example, Acusol®425, Acusol®430, Acusol®445 and Acusol®445ND, and mixtures of these), and the preferred level for use in the composition is from about 0.1% to about 1%.

The composition may also include an alkali metal carbonate builder at a level of from about 1% to about 40%. Most useful in the present invention is sodium carbonate, however potassium carbonate may be used as well. It is well known that sodium carbonate is available in several forms including an anhydrous form as well as three hydrated forms. The hydrated forms include monohydrate, heptandrate and decahydrates. Any of the commercially available forms of sodium or potassium carbonate find use in the present invention.

The detergent composition (as with the softener composition described below) may also contain a colorant or dyes. Dyes are optional ingredients within the compositions of the present invention. Dyes may comprise pigments, or other colorants, chosen so that they are compatible with the other ingredients in the detergent composition, compatible with the manufacturing process, and not attracted to the fabric. For example, a preferred colorant for use in the present invention is Liquitint® Green FS (from Milliken), at from about 0.001% to about 0.1% by weight, based on the composition of detergent or softener. Other dyes such as C.I. Pigment Green #7, C.I. Reactive Green #12, F D & C Green #3, C.I. Acid Blue #80, C.I. Acid Yellow #17, Liquitint® Red MX, F D & C Yellow #5, Liquitint® Violet LS, Fast Turquise GLL, Liquitint® Blue MC, Liquitint® Blue HP, or mixtures thereof are also useful in the compositions of the present invention.

Optional ingredients that may be included in the detergent composition on the substrate include but are not limited to other builders (besides the silicates and carbonates mentioned previously), additional sources of alkalinity or hard water chelation such as borates, tetrasodium-, trisodium-, disodium, or monosodium ethylenediamine tetraacetate (“EDTA” and the corresponding salts from it), phosphates, zeolite, nitrilotriacetic acid (“NTA”, and the corresponding salts from it), bleaching agents (oxygen or chlorine based such as percarbonates, perborates, chloroisoeyanurates, and the like), optical brighteners (for example Tinopal® from CIBA, and the like), dye fixatives, enzymes (such as proteases, amylases, lipases, and cellulases and the like), binders, carrier materials and auxiliary ingredients, and minor amounts of additional perfumes, dyes and colorants, solvents, cationic surfactants, softening or antistatic agents (in addition to what is provided in a separate fabric softener zone on the substrate), water, thickeners, emulsifiers, acids, bases, salts, polymers, bleach catalysts, inorganic or organic absorbents, clays, fabric finishing/surface modifying polymers, pH-control agents, active salts, abrasives, preservatives (for stability and shelf-life) and antimicrobials (for sanitizing clothing for example), antiredeposition and soil-suspending agents (such as carboxymethyl cellulose “CMC”, and other synthetic or natural polymers, and the like), opacifiers, anti-foaming agents (silicone materials for example), cyclodextrin, rheology control agents, vitamins and other skin benefit agents, oils, nanoparticles, visible plastic particles, and other visible beads, glitter, decorative granules, etc.

### The Fabric Softener/Conditioning Composition for Application to the Substrate

The fabric softener composition applied to the substrate of the invention may include a quaternary ammonium cationic surfactant. For brevity, these cationic materials will be referred to as quaternary surfactants with the understanding that they are quaternized nitrogen species (i.e., cationic) and necessarily have an anionic counterion. In this regard, a variety of quaternary surfactants may be utilized, however acyclic quaternary surfactants are preferred. For example, useful quaternary synthetic surfactants that are acyclic include linear alkyl, branched alkyl, hydroxyalkyl, oleylalkyl, acyloxyalkyl, diamidoamine, or diester quaternary ammonium compounds. The preferred quaternary surfactants for use in the present invention are waxy solids at ambient temperature such that the material can be melted and applied hot to the substrate, and these may include traditional tetraalkyl materials or ester quaternaries, or combinations of the two types. Cyclic quaternary materials such as the imidazolines may be used but are less preferred in the present invention. The quaternary surfactant in accordance with a preferred embodiment is at a level from about 40% to about 100% by weight of the fabric softener composition, preferably from about 50% to about 100% and most preferably at a level of about 90-100% of the weight of the softener composition zone on the substrate, in the latter preferred range leaving room in the composition for just fragrance and dyes.

Examples of acyclic quaternary surfactant fabric-softening components useful in the present invention are shown by the general formulae (I) and (II):

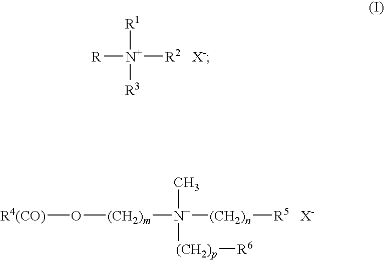

wherein the general formula (I), R and R¹ are individually selected from the group consisting of C₁-C₄ alkyl, benzyl, and —(C₂H₄O)ₓZ where x has a value from 1 to 20 and Z is hydrogen or C₁-C₃ alkyl; R² and R³ are each a C₈-C₃₀ alkyl or R² is a C₃-C₃₀ alkyl and R³ is selected from the group consisting of C₁-C₅ alkyl, benzyl, and —(C₂H₄O)^{x}—H where x has a value from 2 to 5; and where X⁻ represents an anion selected from the group consisting of halides, methyl sulfate, ethyl sulfate, methyl phosphate, acetate, nitrate or phosphate ion and mixtures thereof. Specific examples of quaternary surfactants described within the general formula (I) include alkyltrimethylammonium compounds, dialkyldimethylammonium compounds and trialkylmethylammonium compounds including but not limited to, tallow trimethyl ammonium chloride, ditallow dimethyl ammonium chloride, ditallow dimethyl ammonium methyl sulfate, dihexadecyl dimethyl ammonium chloride, di-(hydrogenated tallow) dimethyl ammonium chloride, dioctadecyl dimethyl ammonium chloride, dieicosyl dimethyl ammonium chloride, didocosyl dimethyl ammonium chloride, di-(hydrogenated tallow) dimethyl ammonium methyl sulfate, dihexadecyl dimethyl ammonium acetate, ditallow dipropyl ammonium phosphate, ditallow dimethyl ammonium nitrate, di-(coconut-alkyl) dimethyl ammonium chloride, cetyltri-methylammonium chloride, stearyltrimethylammonium chloride, distearyldimethylammonium chloride, lauryldimethylammonium chloride, and tricetylmethylammonium chloride, along with other quaternary compounds such as trihydroxyethylmethylammonium methosulfate, lauryldimethylbenzylammonium chloride, and the like. Many of these materials are available under the Varisoft® brand at Degussa.

Quaternary surfactants of the formula (II) are known as ester quats. Ester quats are notable for excellent biodegradability. In the formula (II), R⁴ represents an aliphatic alkyl radical of 12 to 22 carbon atoms which has 0, 1, 2 or 3 double bonds; R⁵ represents H, OH or O—(CO)R⁷, R⁶ represents H, OH or O(CO)R⁸ independently of R⁵, with R⁷ and R⁸ each being independently an aliphatic alkyl radical of 12 to 22 carbon atoms which has 0, 1, 2 or 3 double bonds in, n and p are each independently 1, 2 or 3. X⁻ may be a halide, methyl sulfate, ethyl sulfate, methyl phosphate, nitrate, acetate or phosphate ion and also mixtures thereof. Useful are compounds wherein R⁵ is O—(CO)R⁷ and R⁴ and R⁷ are alkyl radicals having 16 to 18 carbon atoms, particularly compounds wherein R⁶ also represents OH. Examples of compounds of the formula (II) are methyl-N-(2-hydroxyethyl)-N,N-di-(tallow acyloxyethyl)ammonium methyl sulfate, bis-(palmitoyl)-ethylhydroxyethyl methyl ammonium methyl sulfate or methyl-N,N-bis(acyloxyethyl)-N-(2-hydroxyethyl)ammonium methyl sulfate. In quaternary surfactants of the formula (II) which comprise unsaturated alkyl chains, preference is given to acyl groups whose corresponding fatty acids have an iodine number between 5 and 80, preferably between 10 and 60 and especially between 15 and 45 and also a cis/trans isomer ratio (in % by weight) of greater than 30:70, preferably greater than 50:50 and especially greater than 70:30. Commercially available examples are the methylhydroxyalkyldi-alkoyloxyalkylammonium methyl sulfates marketed by Stepan under the Stepantex® brand or the Cognis products appearing under Dehyquart® or the Degussa products appearing under Adogen® and Rewoquat® brands. Most preferred is Adogen 66 from Degussa-Goldschmidt, which is ethylbis-(hydroxyethyl)-tallow alkyl, ethoxylated, Et-sulfate. Further ester quats of use in the present invention have the formulas; [(CH₃)₂N⁺ (CH₂CH₂OC(O)—R)₂]X⁻ or [(HOCH₂CH₂)(CH₃)N⁺ (CH₂CH₂OC(O)—R)₂]X⁻, where R=linear saturated or unsaturated alkyl radical of 11 to 19 and preferably 13 to 17 carbon atoms. In a particularly preferred embodiment the fatty acid residues are tallow fatty acid residues. X⁻ represents either a halide, for example chloride or bromide, methyl phosphate, ethyl phosphate, methyl sulfate, ethyl sulfate, acetate, nitrate, phosphate and also mixtures thereof.

Further useful acyclic quaternary ammonium fabric-softening agents include the diester quats of the formula (III), obtainable under the name Rewoquat® W 222 LM or CR 3099, which provide stability and color protection as well as softness:

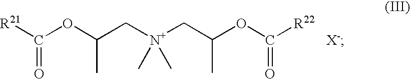

where R²¹ and R²² each independently represent an aliphatic radical of 12 to 22 carbon atoms which has 0, 1, 2 or 3 double bonds.

It is likewise possible to use amidoamine quaternary surfactants of the formula (IV)

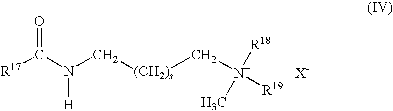

wherein R¹⁷ may be an aliphatic alkyl radical having 12 to 22 carbon atoms with 0, 1, 2 or 3 double bonds, s can assume values between 0 and 5, R¹⁸ and R¹⁹ are, independently of one another, each H, C₁₋₄-alkyl or hydroxyalkyl. Preferred compounds are fatty acid amidoamines such as stearylamidopropyldimethylamine obtainable under the name Tego Amid® S18, or the 3-tallowamidopropyltri-methylammonium methyl sulfate obtainable under the name Stepantex® X 9124, which are characterized not only by a good conditioning effect, but also by color-transfer-inhibiting effect and in particular by their good biodegradability. Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methyl sulfate and/or N-methyl-N-(2-hydroxyethyl)-N,N-(palmitoyloxyethyl)ammonium methyl sulfate. In preferred embodiments of the solid fabric conditioner zone on the substrate comprise Rewoquat® WE-18-E-US (proprietary ester quat from Degussa), Incrosoft® T-90 from Croda, Stepantex® VA-90, or Stepantex® HTS-100 from Stepan, or mixtures thereof, as the quaternary surfactants, preferably present from about 40% to about 100% by weight based on the entire composition. The most preferred composition of the fabric softener zone on the substrate is about 90-100% Stepantex® HTS-100 and/or Varisoft® DS-150 and/or Adogen® 66, along with about 0.1-10% fragrance and an effective amount of a colorant, such that the solidified zone has color for aesthetics and also a fragrance that is capable of transfer to the fabrics in the drying cycle.

For consumer acceptance, product recognition and recall, and most importantly to impart substantive fragrance to the fabrics inside the clothes dryer, a fragrance is preferably added to the fabric softener composition zone of the present invention. Depending on the strength of the fragrance and the character of the perfume notes, the preferred amount of fragrance is from about 0.1% to about 10% by weight, based on the composition of the fabric conditioning composition. Some example fragrances include, but are not limited to, UN063503/00, UN063507/00, UN063506/00, UN063511/00, UN063505/00, and UN063513/00 from Givaudan Fragrances, and Fressia-497 and Mountain Breeze fragrances (from International Flavors and Fragrances). Any fragrance material, either synthetic or naturally derived, or a combination of the two, are useful for both the detergent and the softener zones in the laundry article of the present invention.

In addition to the actives required for anti-static and softening (the quaternary material described above) and fragrancing of the fabrics, the softener zone may also include silicone and aminosilicone compounds, betaines, starches, cationic and amphoteric polymers, anti-wrinkle additives, clays (for example, bentonite), cationic silica, meltable matrix materials like waxes or soaps (preferably fatty alcohols, polyethylene glycols, sorbitan esters, silicone waxes, polyethylene wax, binders, carrier materials, dyes and colorants, optical brighteners, solvents, opacifiers, vitamins and other benefit agents, oils, nanoparticles, visible plastic particles, visible beads or other decorative material occluded into the softener matrix, etc., and the like. For example, fatty alcohol emulsifying waxes such as C₁₀-C₁₈ alcohols may be added to the molten quaternary to form a softener melt composition that can be applied to the substrate. When fatty alcohols are needed, a preferred alcohol is “cetearyl” alcohol (a mixture of cetyl and stearyl alcohols) such as Lanette® O available from Cognis, and these materials are simply co-melted with the quaternary prior to application to the substrate. The softener compositions are mostly insoluble during a typical cold or warm wash cycle. The softener zone on the substrate has a lower contact angle if wetted with water and shows no tendency of water uptake in humid storage conditions. The zones of the fabric softener compositions show no tackiness and do not stick to consumer's hands after storage in humid storage conditions. As mentioned previously, when using a preferred nonwoven material as the substrate, the fabric softener zone may be entirely quaternary, with minor amounts of dyes and perfumes. That is, there is no need for a fatty alcohol matrix and release material as described in the prior art.

### Articles of the Present Invention and Methods of Production

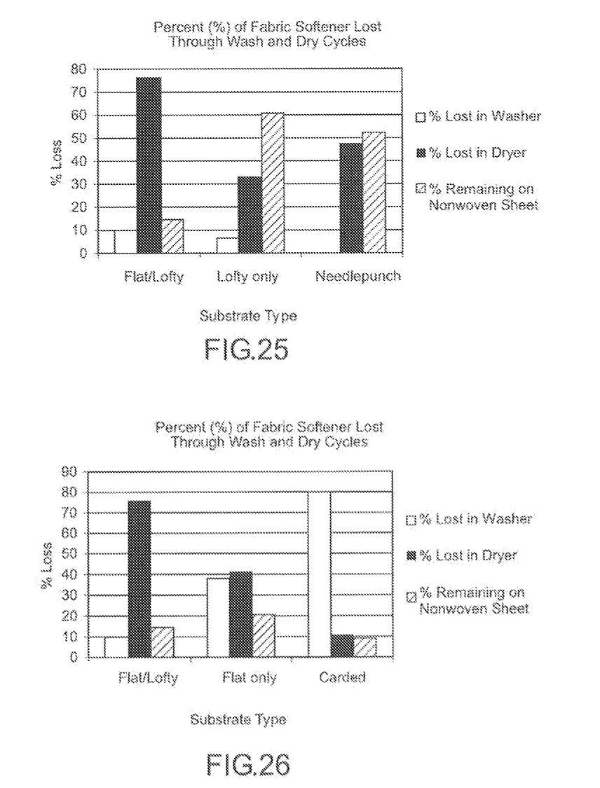

Specific, but non-limiting embodiments of the laundry article of the present invention are delineated in Tables 1-3 below. Table 1 shows combinations of the detergent ingredients described above to produce detergent compositions suitable for application to the substrate. The compositions 1-10 listed in Table 1 are “theoretical amounts” in weight percent (wt. %), that is, the compositions were calculated to reflect what was in the batch after mixing, with the wt. % water being the sum of any water contributed from individual raw materials that are commercially supplied at less than 100% actives. However, composition 1 represents the theoretical amounts of ingredients of a conventional laundry detergent after drying on the substrate since this composition began as an ordinary liquid, (hence the indication “dried”, meaning 0% on the substrate). The remaining compositions 2-10 were all heated co-melts and the theoretical amounts shown are also the amounts on the substrate since any water in the composition tends to stay within the waxy zone. Table 2 shows combinations of the ingredients described above to produce fabric softening/conditioning/anti-stat compositions 11-17 suitable for application to the substrates. As with the previous table, Table 2 represents theoretical or actives percent (wt. %). Lastly, Table 3 shows combinations of the compositions from Tables 1 and 2 on various substrate materials at various loading weights to produce laundry articles of the present invention. Shown in Table 4 and in FIGS. 25-27 arc various performance attributes, such as the whiteness maintenance (cleaning performance), the amount of fabric softener delivered from the substrate to the clothes in the dryer, and so forth, which is explained in more detail below.

TABLE 1
Example detergent compositions for application to a substrate

| | Weight Percent (actives %) | | | | |
|---|---|---|---|---|---|
| Ingredients | 1 | 2 | 3 | 4 | 5 |
| Sodium dodecyl benzene sulfonate | 13.56 | 17.30 | 15.60 | 17.70 | 16.70 |
| Sodium alkyl C₁₄-C₁₅/7EO ether sulfate | 28.02 | — | — | — | — |
| Sodium lauryl sulfate (SDS) | — | — | — | — | — |
| C₁₄-C₁₈ fatty acid sodium salt | — | — | — | — | — |
| Linear alcohol ethoxylate C₁₄-C₁₅/7EO | 18.08 | 5.40 | 14.60 | 5.50 | 5.20 |
| Linear alcohol ethoxylate C₁₂-C₁₅/9EO | — | — | — | — | — |
| Linear alcohol ethoxylate C₁₂-C₁₄/12EO | — | — | — | — | — |
| Coconut monoethanolamide | — | — | — | — | — |
| Polyethylene Glycol PEG-75 | — | 1.40 | 1.30 | 1.40 | 1.40 |
| Polyoxyethylene (100) stearyl ether | — | 15.60 | 14.10 | 15.90 | 15.10 |
| Sodium Silicate SiO₂/Na₂O ratio 1.6-1.8 | — | 16.60 | 15.00 | 17.00 | 16.00 |
| Sodium Silicate (Britesil ® C24) | — | — | — | — | — |
| Sodium Carbonate | 35.26 | 6.50 | 5.90 | 6.70 | 6.30 |
| Sodium tetraborate decahydrate | — | 11.90 | 10.80 | 12.20 | 11.50 |
| Sodium polyacrylate ~4,500 MW | 2.26 | 1.80 | 1.70 | - | 5.20 |
| EDTA - tetrasodium salt | 0.72 | 0.10 | 0.10 | 0.10 | 0.10 |
| Optical brightener (Tinopal ®) | 0.54 | 0.10 | 0.09 | 0.10 | 0.10 |
| Quaternary surfactant (softener) | — | — | — | — | — |
| Dyes and fragrances | 1.56 | 0.90 | 0.81 | 1.01 | 0.91 |
| Water | (dried) | 22.10 | 19.90 | 22.40 | 21.50 |

| | Weight Percent (actives %) | | | | |
|---|---|---|---|---|---|
| Ingredients | 6 | 7 | 8 | 9 | 10 |
| Sodium dodecyl benzene sulfonate | 25.44 | 30.80 | 20.70 | 24.18 | 26.09 |
| Sodium alkyl C₁₄-C₁₅/7EO ether sulfate | — | — | 19.00 | 12.79 | 13.80 |
| Sodium lauryl sulfate (SDS) | 3.14 | — | 2.70 | — | — |
| C₁₄-C₁₈ fatty acid sodium salt | — | — | — | — | — |
| Linear alcohol ethoxylate C₁₄-C₁₅/7EO | 7.88 | 8.50 | 6.50 | 12.45 | 13.44 |
| Linear alcohol ethoxylate C₁₂-C₁₅/9EO | — | — | — | — | — |
| Linear alcohol ethoxylate C₁₂-C₁₄/12EO | — | — | — | — | — |
| Coconut monoethanolamide | — | — | — | — | — |
| Polyethylene Glycol PEG-75 | 2.07 | 2.20 | 1.70 | 1.85 | 2.00 |
| Polyoxyethylene (100) stearyl ether | 23.25 | 24.60 | 18.70 | 20.38 | 21.99 |
| Sodium Silicate SiO₂/Na₂O ratio 1.6-1.8 | 7.78 | 8.40 | 6.40 | 9.93 | 3.72 |
| Sodium Silicate (Britesil ® C24) | 2.70 | 3.60 | 2.70 | — | 7.00 |
| Sodium Carbonate | — | — | — | — | — |
| Sodium tetraborate decahydrate | — | — | — | — | — |
| Sodium polyacrylate ~4,500 MW | 1.80 | — | — | — | — |
| EDTA - tetrasodium salt | 0.17 | — | — | — | — |
| Optical brightener (Tinopal ®) | 0.10 | 0.20 | 0.10 | 0.13 | 0.15 |
| Quaternary surfactant (softener) | — | — | — | — | — |
| Dyes and fragrances | 1.54 | 1.41 | 1.11 | 0.84 | 0.90 |
| Water | 24.12 | 20.40 | 20.50 | 17.44 | 10.92 |

| | Weight Percent (actives %) | | |
|---|---|---|---|
| Ingredients | 1A | 2A | 3A |
| Sodium dodecyl benzene sulfonate | 43.60 | 6.95 | 29.05 |
| Sodium alkyl C₁₄-C₁₅/7EO ether sulfate | — | — | — |
| Sodium lauryl sulfate (SDS) | — | 9.87 | — |
| C₁₄-C₁₈ fatty acid sodium salt | — | — | — |
| Linear alcohol ethoxylate C₁₄-C₁₅/7EO | — | — | 7.37 |
| Linear alcohol ethoxylate C₁₂-C₁₅/9EO | — | — | — |
| Linear alcohol ethoxylate C₁₂-C₁₄/12EO | — | 33.64 | — |
| Coconut monoethanolamide | — | 17.11 | — |
| Polyethylene Glycol PEG-75 | — | — | 2.17 |
| Polyoxyethylene (100) stearyl ether | — | — | 29.05 |
| Sodium Silicate SiO₂/Na₂O ratio 1.6-1.8 | 11.28 | — | — |
| Sodium Silicate (Britesil ® C24) | — | — | — |
| Sodium Carbonate | 27.00 | 10.16 | 9.97 |
| Sodium tetraborate decahydrate | — | 18.28 | 18.21 |
| Sodium polyacrylate ~4,500 MW | 4.60 | 0.95 | 2.43 |
| EDTA - tetraspdium salt | — | — | 0.43 |
| Optical brightener (Tinopal ®) | 0.30 | 0.15 | 0.17 |
| Quaternary surfactant (softener) | — | 1.83 | — |
| Dyes and fragrances | 0.50 | 1.06 | 1.13 |
| Water | 12.72 | nil | 5.2 |

TABLE 2
Example softener compositions for application to a substrate

| | Weight Percent (actives %) | | | | |
|---|---|---|---|---|---|
| Ingredients | 11 | 12 | 13 | 14 | 15 |
| Quaternary (Adogen ® 66) | 60.00 | 10.00 | — | — | — |
| Quaternary (Stepantex ® HTS-100) | — | — | 95.00 | 75.00 | 47.50 |
| Quaternary (Varisoft ® DS-150) | — | — | — | — | — |
| Cetearyl alcohol (Lanette ®-O) | 40.00 | 90.00 | — | 25.00 | 47.50 |
| Fragrance oil | — | — | 5.00 | — | 5.00 |
| Dyes | q.s | q.s | q.s | q.s. | q.s. |

| | Weight Percent (actives %) | |
|---|---|---|
| Ingredients | 16 | 17 |
| Quaternary (Adogen ® 66) | — | — |
| Quaternary (Stepantex ® HTS-100) | — | — |
| Quaternary (Varisoft ® DS-150) | 50.00 | 95.24 |
| Cetearyl alcohol (Lanette ®-O) | 50.00 | — |
| Fragrance oil | — | 4.76 |
| Dyes | q.s | q.s |

TABLE 3
Laundry Article Examples

| | Weight composition (g) of compositions | | | | | | | | | |
|---|---|---|---|---|---|---|---|---|---|---|
| | loaded on the particular substrate indicated | | | | | | | | | |
| Ingredients | A | | B | | C | | D | | E | |
| Detergent composition | (1) 12 g | | (1) 12 g | | (1) | 12 g | (1) | 12 g | (1) | 12 g |
| Fabric softener composition | — | | — | | (11) | 3.3 g | (12) | 20 g | (13) | 2 g |
| Nonwoven** | S1 | | S2 | | T1 | | T1 | | T1 | |
| | Weight composition (g) of compositions | | | | | | | | | |
| | loaded on the particular substrate indicated | | | | | | | | | |
| Ingredients | F | | G | | H | | I | | J | |
| Detergent composition | (1) | 12 g | (1) | 12 g | (2) | 8 g | (2) | 8 g | (9) | 12 g |
| Fabric softener composition | (14) | 2.7 g | (15) | 4 g | (16) | 1.5 g | (17) | 1.5 g | (17) | 1.5 g |
| Nonwoven** | T1 | | T1 | | H1 | | H1 | | A1 | |
| | Weight composition (g) of compositions | | | | | | | | | |
| | loaded on the particular substrate indicated | | | | | | | | | |
| Ingredients | K | | L | | M | | N | | O | |
| Detergent composition | (9) | 12 g | (9) | 12 g | (9) | 12 g | (9) | 12 g | (9) | 12 g |
| Fabric softener composition | (17) | 1.5 g | (17) | 1.5 g | (17) | 1.5 g | (17) | 1.5 g | (17) | 1.5 g |

| Nonwoven** | A2 | | A3 | H2 | H1 | H3 |
|---|---|---|---|---|---|---|
| | Weight composition (g) of compositions | | | | | |
| | loaded on the particular substrate indicated | | | | | |
| Ingredients | P | | Q | R | S | T |
| Detergent composition | (9) | 12 g | (1) 10 g | (2) 10 g | (3) 10 g | (4) 10 g |
| Fabric softener composition | (17) | 1.5 g | — | — | — | — |

| Nonwoven** | H4 | H1 | H1 | | H1 | H1 | |
|---|---|---|---|---|---|---|---|
| | Weight composition (g) of compositions | | | | | | |
| | loaded on the particular substrate indicated | | | | | | |
| Ingredients | U | V | W | | X | Y | |
| Detergent composition | (5) 10 g | (6) 10 g | (7) 10 g | | (8) 10 g | (9) 10 g | |
| Fabric softener composition | — | — | — | | — | — | |
| Nonwoven** | H1 | H1 | H1 | | H1 | H1 | |
| | Weight composition (g) of compositions | | | | | | |
| | loaded on the particular substrate indicated | | | | | | |
| Ingredients | Z | AA | AB | | AC | AD | |
| Detergent composition | (10) 10 g | (4) 8 g | (4) | 8 g | (4) 12 g | (4) | 12 g |
| Fabric softener composition | — | — | (17) | 1.5 g | — | (17) | 1.5 g |

| | | | | | |
|---|---|---|---|---|---|
| Nonwoven** | H1 | H1 | H1 | H1 | H1 |

*First number in parentheses denotes composition number from Tables 1 and 2; second number indicates loading (g). Note articles using detergent composition 1 are dried down weights (e.g., 12 g after drying out the water content)
**Nonwoven materials are follows: S1-Sandler Sawaloom ® 2611, 100% viscose; S2-Sandler Sawaloom ® 2621, 100% PET; S3-Sandler Sawaloom ® 6000, viscose/PET/PP; S4-Sandler Sawaloom ® 6351, viscose/PET/PP; S5-Sandler Sawaloom ® 6600, viscose/PET/PP; S6-Sandler Sawaloom ® 6700, CV/PET/PP; T1-Texel ® 04531, viscose/polyester; T2-Texel ® 04531, viscose/polyester; H1-HDK 401; H2-HDK 330; H3-HDK #4; H4-HDK #5, H5-HDK #2; A1-Ahlstrom 11B04.3110; A2-Ahlstrom VPM7.1; A3-Ahlstrom Needlepunch.

TABLE 4
Performance attributes of various laundry articles

| | Performance Attributes | | | |
|---|---|---|---|---|
| | | | Softener | |
| Laundry Article | Whiteness | Static | in Dryer | |
| (from Table 3) | Maintenance | Reduction | (%) | Observations/Comments |
| A | — | — | — | Poor-lacked mechanical strength to survive |
| | | | | wash/dry |
| B | — | — | — | Poor-lacked absorbency for the compositions |
| C | — | 1.11 | — | Poor-long dry times, tacky feel |
| D | — | 0.38 | — | Poor-long dry times, tacky feel |
| E | — | 2.61 | — | Poor-long dry times, tacky feel |
| F | — | 0.36 | — | Poor-long dry times, tacky feel |
| G | — | 0.20 | — | Poor-long dry times, tacky feel |
| H | — | 0.17 | — | Good |
| I | — | 0.12 | — | Good |
| J | — | — | 41.35 | Fair |
| K | — | — | 10.03 | Fair |
| L | — | — | 47.36 | Fair |
| M | — | — | 71.38 | — |
| N | — | — | 75.88 | — |
| O | — | — | 86.25 | Superior release of fabric softener from the |
| | | | | substrate |
| P | — | — | 77.61 | — |
| Q | 98.40 | — | — | Conventional liquid laundry detergent (1) |
| | | | | dried on substrate - standard benchmark for |
| | | | | whiteness testing |
| R | 75.20 | — | — | Poor whiteness maintenance |
| S | 78.11 | — | — | Poor whiteness maintenance |
| T | 86.48 | — | — | Reasonable whiteness maintenance |
| U | 70.92 | — | — | Poor whiteness maintenance |
| V | 83.50 | — | — | Reasonable whiteness maintenance |
| W | 98.90 | — | — | Whiteness maintenance exceeded benchmark |
| X | 95.10 | — | — | Whiteness maintenance neared benchmark |
| Y | 98.70 | — | — | Whiteness maintenance exceeded benchmark |
| Z | 98.80 | — | — | Whiteness maintenance exceeded benchmark |
| AA | 86.60 | — | — | Reasonable whiteness maintenance |
| AB | 89.88 | — | — | Reasonable whiteness maintenance |
| AC | 92.65 | — | — | Whiteness maintenance neared benchmark |
| AD | 93.34 | — | — | Whiteness maintenance neared benchmark |

### Methods of Producing the Compositions and the Laundry Articles of Tables 1-3

For the softener compositions 11-15 in Table 2, the quaternary surfactant Stepantex FITS-100 and optionally cetearyl alcohol were heated until melted (around 65° C.) and then mixed with the optional perfume until uniform. The hot molten mixture may be applied to various sheets of nonwoven at the weights indicated in Table 3. Mixtures of various preferred quaternaries may be co-melted together as necessary.

Co-melted detergent example: 275 grams of Brij 700 (polyoxyethylene-100 stearyl ether, Uniqema) and 25 grams of Carbowax 3350 (Union Carbide) were combined in a large vessel and heated to 85° C. to allow the solids to melt. 85 g of Neodol 45-7 (C₄-C₁₅ primary alcohol ethoxylate 7 EO, Shell Chemicals) and 335 g of Calsoft F-90 (sodium linear alkylbenzene sulfonate, Pilot chemical company) were added to the heated mixture and allowed to thoroughly mix. 210 g of borax decahydrate, 115 g of anhydrous sodium carbonate, 2 g Tinopal CBS-X (Ciba), 28 g Acusol 430 (polyacrylate, Rohm and Haas), 4 g Liquitint blue HP (1% solution, Milliken), 5 g Tetrasodium EDTA, and 9 g perfume (Mt Breeze, IFF) were added. The detergent ingredients were thoroughly mixed at 85° C. Optionally the viscosity may be adjusted by adding up to 6% by weight water. Typically around 1-100 g of any of the melted detergent compositions is coated onto a nonwoven where it solidifies upon cooling.

Additional co-melted detergent example such as 2A in Table 1: 234 grams of Mackamide CMA (cocamide MEA, McIntyre Group LTD.) was placed into a large vessel and heated to 85° C. while stirring to allow solids to melt. 460 g of Surfonic L24-12 (C₁₂-C₁₄/12EO alcohol ethoxylate from Huntsman Corporation) was added and mixed thoroughly. 95 g of Calsoft F-90 (sodium linear alkylbenzene sulfonate, Pilot chemical company) was added slowly. Finally, 250 g of borax decahydrate, 139 g of anhydrous sodium carbonate, 135 g sodium dodecyl Sulfate, 2 g Tinopal CBS-X (Ciba), 13 g Acusol 445 ND (polyacrylate, Rohm and Haas), 4.5 g Liquitint blue HP (1% solution, Milliken), 25 g Varisoft DS150 (dihydrogenated tallow dimethyl ammonium methylsulfate, Degussa-Goldschmidt) and 10 g perfume (Mt Breeze, IFF) are added and the final mixture is thoroughly mixed at 85° C. 1-100 g of the resultant melt is then coated on a nonwoven where it solidifies upon cooling.

### Example Commercial Processing Description

Both detergent and Softener Strip formulas are blended at elevated temperatures (120° F.-190° F.) using standard mix tanks and agitation. Order of addition can vary based on mixing and heating capabilities of the system. One process to apply the detergent stripe to the substrate uses a Gravure/Kiss type of application where the nonwoven is passed over a rotating cylinder that has been coated with the detergent strip blend. The cylinder is partially submerged in a trough of detergent blend and rotates to coat itself and thereby transfer the detergent to the nonwoven. A detergent weight of 5-20 grams can be achieved in a 5-inch by 6-inch nonwoven area when process parameters are: Line speed 5-30 feet/second; Cylinder speed 5-30 rpms; Trough temperature 120° F.-190° F.; Cylinder temperature 120° F.-190° F. The detergent stripe can also be coated using a slot dye system that precisely meters the correct detergent weights on to the area of the nonwoven.

The process to apply the softener strip to the nonwoven can be as simple as valved, gravity feed from a tank through an appropriately sized slot or hole. Weights, in this care, are controlled by line speed, the temperature of the blend, and the metering valve setting. A more precise application method is the using of a slot dye system that accurately meters the softener strip blend onto the nonwoven as it passes the slot die.

### Test Methods:

Whiteness maintenance was tested according to US Patent Application No. 2006/0183656 “Enhanced Whiteness”, incorporated herein in its entirety. Static Reduction: In a standard US washing machine medium size load of ballast (5 lbs. Of poly/cotton pillowcases), 150 ppm hardness water, detergent and cotton fabric swatches are run through the normal wash cycle. The fabrics are then transferred to a standard US clothes dryer and the fabrics dried on “high” for a predetermined time. At the conclusion of the drying cycle the fabric swatches are removed one at a time and placed against a static meter. This reading is recorded and averaged. During a test the negative control is a load of fabric washed and dried without any additives in the washer or dryer. The negative control result is then normalized to 1 and this factor is used to normalize the other readings in the test. Nonwoven processibility: The detergent was applied to the various nonwovens and the processibility determined by the amount of time required for the detergent to dry and solidify on the substrate. After solidification and thorough cooling, tackiness was determined by touching the detergent area. Percent of softener delivered in the dryer: As the laundry article is manufactured the exact weight of softener applied to the article is measured. After the wash cycle, the laundry article is weighed again to determine the amount of fabric softener lost in the washer. After the drying cycle, the laundry article is weighted to determine the amount of softener distributed from the article in the dryer. It has been shown that the percentage of fabric softener delivered in the dryer directly corresponds to the static reduction expected for the laundry article.

For evaluation purposes, under U.S. wash conditions, Kenmore Elite washers and dryers were used. The following conditions were used: Medium load, Warm wash (100° F.), Cold rinse, Heavy duty agitation, 14 minute wash cycle, 1 rinse. Add hard water to 150 ppm. Allow wash water to fill. Put detergent sheet prototype in water and allow agitating for 30 seconds. Add about 5.5 lbs. of ballast (approximately 50 polyester/cotton washcloths or other suitable ballast). When washing machine has finished wash cycle, transfer load including sheet prototype to the dryer appliance. Evaluate fragrance of wet ballast. Washing performance evaluation is typically based on a standard stain set. This set of stains includes oily/greasy stains, highly colored food stains, protein-based stains, starch-based stains, and particulate stains that are representative of the type of stains frequently encountered by consumers. There are numerous manufacturers of test stains for assessing detergent performance for example: Empirical Manufacturing Corporation, EMPA, and Test Fabrics. These manufacturers produce both individual stains for testing or fabric swatches with up to 18 applied stains. The EMPA 102 is representative of a multi-stain swatch as it contains 17 stains that span the range of stains listed above. Typically, the determination of the cleaning performance requires replicated washing experiments to obtain statistically significant differences in cleaning. It is common that 3-10 replicates are required for significant results due to the level of inherent variability of the methods and materials. The assessment of the removal of individual stain is determined by the color change of the stains as determined using a colorimeter. Wipe insides of dryer with terry washcloth soaked with isopropanol. Allow drying. Set dryer for 60 minutes at high temperature (high/cotton setting). Use a lab timer to time the drying cycle and stop after 50 minutes. This is to assure that the dryer does not cool down towards the end of the cycle. Evaluate fragrance using expert panel of 10 trained individuals. Evaluation takes place on a scale from 1 (no effect) to 5 (very high effect).

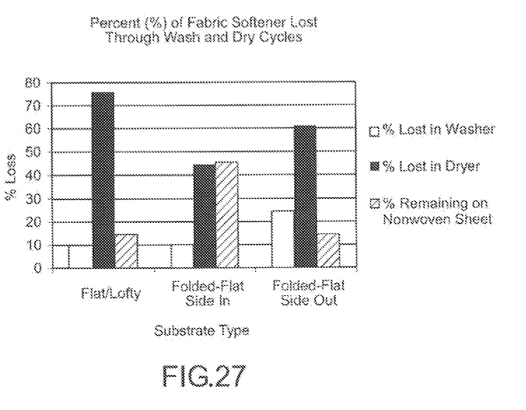

The retention of the fabric softener through the washer and its efficient delivery in the clothes dryer is shown graphically for a number of substrates, either left open or folded in various configurations in FIGS. 25-27. FIG. 25 shows the result of using a Flat/Lofty substrate such as HDK 401 from HDK Industries, Inc., versus a “Lofty Only” substrate, such as HDK #2 from HDK Industries, Inc., and a needlepunched nonwoven such as Ahlstrom needlepunch. These three different substrates show considerably different efficiencies with the same fabric softener composition 13 (Table 2). As shown by the results in FIG. 25, a nonwoven with sidedness (i.e., a flat and lofty side, and non-uniform cross-section) outperforms a similar nonwoven with only lofted sides (uniform cross-section), and a needlepunch substrate that was known for use in many prior art articles. The nonwoven with a non-uniform cross section resulted in only 10% of softener lost in the wash machine and an impressive 75% delivery off the nonwoven in the clothes dryer. Similarly as shown by the results in FIG. 26, a nonwoven with sidedness (i.e., a flat and lofty side, and non-uniform cross-section) outperforms another similar nonwoven with only flat sides Ahlstrom 11B04.3110, having uniform cross-section, and a traditional carded web such as Ahlstrom VPM7.1. The nonwoven with a non-uniform cross section resulted in only 10% of softener lost in the wash machine and an impressive 75% delivery off the nonwoven in the clothes dryer. The ability for the preferred layered substrate to give a high retention of fabric softener in the washer and a corresponding high delivery of softener in the dryer is due to the sidedness. Indeed, the lofty side helps hold on to the fabric softener in the washer, and the flat side allows delivery of softener in the dryer. FIG. 27 shows that the release of the fabric softener from the substrate is preferentially from the flat denser side that was formed with finer denier fibers. As shown in FIG. 27, if the substrate is folded on itself and stapled closed, there is a marked difference in the amount of fabric softener retained through the wash and the amount of fabric softener delivered in the dryer depending on whether or not the flat side is left out or in. The data shows that the softener preferentially distribute out through the flat side of the non-uniform cross-section nonwoven, since if the article is folded and stapled with flat coated sides in, the fabric softener remains trapped inside the folded article. However, if the coated lofted side is folded in and the flat side is left out, the fabric softener wicks out through the folded article. Not wishing to be bound by any theory, it is believed that the fabric softener partially melts and/or volatilizes out through the finer fibers due to a “wicking” or capillary action across the gradient of fiber diameters and densities. Thus, FIG. 27 show that the preferred substrate is a nonwoven with a non-uniform cross-section, having both flat and lofted sides, and this result is unanticipated and heretofore entirely unknown.

We have described laundry articles used for both the washing and conditioning of fabrics that have at least two composition zones that deliver significant amounts of fragrance and fabric conditioning benefits to the fabrics in the dryer after having been retained on the substrate through the washing machine. The articles of the present invention have also been shown to have good cleaning performance and have been optimized to give comparable whiteness maintenance to liquid laundry detergents. The articles have been optimized by incorporating a nonwoven substrate with a non-uniform cross-section, in particular a layered nonwoven with at least two types of fibers and having a flat tighter bonded and a lofty looser bonded side. We have also described methods of manufacturing such articles that include, but are not limited to, the application of hot-melts for both the detergent and the fabric softener compositions. We have also described a method for cleaning and conditioning fabrics that comprises using the article of the present invention in the clothes washing machine and then carrying it along with the wet clothes into the dryer where the fabric conditioning composition is liberated from the substrate and onto the fabrics in the dryer. Lastly, we have described compositions for melt-cast laundry detergents that may be molded into single-use shapes in processes similar to the candy industry, or dripped molten through a heated weir-box onto chill-belts to produce pellets or pastilles of waxy-appearing laundry detergent that may be boxed in bulk and marketed as substitutes for dusty laundry detergent powders.

We claim:

1. A laundry article used for both cleaning and conditioning fabrics comprising:
a. a water-insoluble nonwoven substrate having a non-uniform cross-section;
b. a detergent composition solidified on the substrate in at least one zone; and,
c. a fabric conditioning composition solidified on the substrate in at least one zone;
wherein said substrate has a thickness from about 50 to about 200 mils, an air permeability from about 70 to about 700 cubic ft. per minute, a MD tensile strength of from about 10.0 to about 35.0 lbs./in., a CD tensile strength of from about 2.0 to about 8.0 lbs./in., and a basis weight of from about 2.0 to about 7.0 osy.

2. The article of claim 1, wherein the nonowoven substrate comprises fibers selected from the group consisting of polyester, polyethylene, polypropylene, polyethylene terephthalate, polybutylene terephthalate, nylon, rayon, and acrylic, and mixtures thereof.

3. The article of claim 2, wherein said fibers include at least two separate average fiber diameters, said average diameters chosen within the range of from about 1.5 to about 15 denier.

4. The article of claim 3, wherein said substrate comprises at least two laminated layers of fiber webs.

5. The article of claim 4, wherein said substrate includes a flat side comprised primarily of smaller denier and more tightly bonded fibers and a lofted side comprised primarily of larger denier and more loosely bonded fibers.

6. The article of claim 1, wherein the detergent composition is comprised of at least one anionic material and at least one nonionic material.

7. The article of claim 5, wherein the detergent composition is comprised of at least one anionic material and at least one nonionic material.

8. The article of claim 7, wherein the anionic material is chosen from the group consisting of sulfonates, sulfates, and fatty acid soaps, or mixtures thereof.

9. The article of claim 8, wherein the nonionic material is chosen from the group consisting of alcohol ethoxylates, fatty acid alkanolamides, alkyl polyglucosides, polyoxyethylene cetyl ethers, polyoxyethylene oleyl ethers, polyoxyethylene stearyl ethers, polyoxyethylene lauryl ethers, polyoxyethylene isocetyl ethers, polyoxyethylene isostearyl ethers, polyoxyethylene octydodecyl ethers, polyoxyethylene behenyl ethers, polyoxyethylene decyltetradecyl ethers, polyoxyethylene chloesteryl ethers, polyoxyethylene-polyoxypropylene ethers, fatty acid monoglycerides, fatty acid triglycerides, polyethylene glycol, polypropylene glycol, polyethyleneglycol monostearates, polyethyleneglycol monooleates, polyethyleneglycol monolaurate, polyoxyethylene hydrogenated castor oils, polyoxyethylene glyceryl monostearates, polyethyleneglycol monoisostearates, polyoxyethylene castor oils, polyoxyethylene cetyl ether stearates, polyoxyethylene stearyl ether stearates, polyoxyethylene lauryl ether stearates, polyoxyethylene lauryl ether isostearates, polyethyleneglycol dilaurates, polyethyleneglycol distearates, polyethyleneglycol diisostearates, polyethyleneglycol dioleates, polyethylene sorbitan fatty acid esters, and polyethylene sorbitan fatty acid esters, and mixtures thereof.

10. The article of claim 1, wherein said fabric conditioning composition includes a quaternary surfactant.

11. The article of claim 10, wherein said fabric conditioning composition further includes a fatty alcohol.

12. The article of claim 10, wherein the detergent composition is comprised of at least one anionic material and at least one nonionic material.

13. The article of claim 12, wherein the anionic material is chosen from the group consisting of sulfonates, sulfates, and fatty acid soaps, or mixtures thereof.

14. The article of claim 13, wherein said nonionic material is chosen from the group consisting of alcohol ethoxylates, fatty acid alkanolamides, alkyl polyglucosides, polyoxyethylene cetyl ethers, polyoxyethylene oleyl ethers, polyoxyethylene stearyl ethers, polyoxyethylene lauryl ethers, polyoxyethylene isocetyl ethers, polyoxyethylene isostearyl ethers, polyoxyethylene octydodecyl ethers, polyoxyethylene behenyl ethers, polyoxyethylene decyltetradecyl ethers, polyoxyethylene chloesteryl ethers, polyoxyethylene-polyoxypropylene ethers, fatty acid monoglycerides, fatty acid triglycerides, polyethylene glycol, polypropylene glycol, polyethyleneglycol monostearates, polyethyleneglycol monooleates, polyethyleneglycol monolaurate, polyoxyethylene hydrogenated castor oils, polyoxyethylene glyceryl monostearates, polyethyleneglycol monoisostearates, polyoxyethylene castor oils, polyoxyethylene cetyl ether stearates, polyoxyethylene stearyl ether stearates, polyoxyethylene lauryl ether stearates, polyoxyethylene lauryl ether isostearates, polyethyleneglycol dilaurates, polyethyleneglycol distearates, polyethyleneglycol diisostearates, polyethyleneglycol dioleates, polyethylene sorbitan fatty acid esters, and polyethylene sorbitan fatty acid esters, and mixtures thereof.

15. The article of claim 14, wherein said detergent composition further includes builders selected from the group consisting of silicate, borate, carbonate, bicarbonate, citrate, and phosphate, and mixtures thereof.

16. The article of claim 15, wherein said detergent composition further includes a sodium polyacrylate with molecular weight from about 1000 to about 10,000.

17. The article of claim 16, wherein said detergent composition further includes ingredients selected from the group consisting of dyes, pigments, fragrances, fabric softeners, chelants, soil suspension polymers, soil anti-redeposition polymers, bleaches, and enzymes, and mixtures thereof.

18. The article of claim 10, wherein said fabric conditioning article further includes ingredients selected from the group consisting of dyes, pigments, fragrance, starches, anti-wrinkle agents, silicone polymers, and silicone waxes; and mixtures thereof.

19. The article of claim 17, wherein said detergent composition includes sulfates selected from the group consisting of sodium or magnesium dodecylbenzene sulfonate, sodium or magnesium alkyl ether sulfate, sodium or magnesium alkyl sulfate, and sodium or magnesium or ammonium fatty acid soap, and mixtures thereof.

20. The article of claim 1 further comprising a perforation across either the length or the width of the article, such that the perforation falls between said zones of detergent or fabric conditioning compositions and separates at least one zone from the remaining zones.

21. The article of claim 1 further comprising a perforation across either the length or width of the article, such that the perforation runs through at least one of said zones of detergent or fabric conditioning compositions.

22. A laundry article used for both cleaning and conditioning fabrics comprising:
a. a water-insoluble nonwoven substrate having a non-uniform cross-section, said substrate comprised of at least two average fiber diameters carded into at least two webs that are laminated together and thermally or powder/thermally processed to create a flat side comprised primarily of smaller denier and more tightly bonded fibers and a lofted side comprised primarily of larger denier and more loosely bonded fibers;
b. a detergent composition solidified in at least one zone on said substrate, said composition including ingredients selected from the group consisting of alkyl benzene sulfonates, alkyl ether sulfates, alkyl sulfates, fatty acid soaps, fatty acid alkanolamides, alpha-sulfonated fatty acid methyl esters, alkyl polyglycosides, alcohol ethoxylates, sulfosuccinates, betaines, polyethylene glycols, polyoxyethylene fatty alcohol ethers, fatty alcohols, borates, silicates, carbonates, bicarbonates, phosphates, citrates, tetrasodium ethylene diamine tetraacetatc, trisodium nitrilotriacetate, sodium polyacrylate, fragrances, and dyes, and mixtures thereof; and,
c. a fabric conditioning composition solidified in at least one zone on said substrate, said fabric conditioning composition including ingredients selected from the group consisting of quaternary surfactants, fatty alcohols, starches, fragrances, polyethylene glycols, waxes, dyes, and silicones, and mixtures thereof.

23. The article of claim 10 further comprising an additional fabric treatment composition applied in at least one additional zone on said substrate.

24. The article of claim 22 further comprising an additional fabric treatment composition applied in at least one additional zone on said substrate.

25. The article of claim 23 further comprising a perforation across either the length or the width of the article, such that the perforation falls between said zones of detergent or fabric conditioning compositions and separates at least one zone from the remaining zones.

26. The article of claim 23 further comprising a perforation across either the length or width of the article, such that the perforation runs through at least one of said zones of detergent or fabric conditioning compositions.

27. The article of claim 24 further comprising a perforation across either the length or the width of the article, such that the perforation falls between said zones of detergent or fabric conditioning compositions and separates at least, one zone from the remaining zones.

28. The article of claim 24 further comprising a perforation across either the length or width of the article, such that the perforation runs through at least one of said zones of detergent or fabric conditioning compositions.

29. A method of producing the laundry article of claim 1 comprising the steps of:
a. melting a detergent composition;
b. melting a fabric softener composition;
c. supplying a length of nonwoven substrate having a non-uniform cross-section; and,
d. coating said substrate with both the molten detergent composition and the molten fabric softener composition into at least one zone each and allowing the resulting detergent and fabric softener composition zones to cool and solidify on the substrate.

30. A method of producing the laundry article of claim 19 comprising the steps of:
a. melting a detergent composition;
b. melting a fabric softener composition;
c. supplying a length of nonwoven substrate having a non-uniform cross-section; and,
d. coating said substrate with both the molten detergent composition and the molten fabric softener composition into at least one zone each and allowing the resulting detergent and fabric softener composition zones to cool and solidify on the substrate.

31. A method of producing the laundry article of claim 9 comprising the steps of:
a. co-melting a detergent composition comprising anionic and nonionic materials;
b. co-melting a fabric softener composition comprising at least one quaternary surfactant;
c. supplying a length of nonwoven substrate constructed of carded fibers layers having a non-uniform cross-section and both a flat side and a lofted side; and,
d. coating said lofted side of said substrate with both the molten detergent composition and the molten fabric softener composition into at least one zone each and allowing the resulting detergent and fabric softener composition zones to cool and solidify on the substrate.

32. A method of producing the laundry article of claim 22 comprising the steps of:
a. melting a detergent composition, said composition including ingredients selected from the group consisting of alkyl benzene sulfonates, alkyl ether sulfates, alkyl sulfates, fatty acid soaps, fatty acid alkanolamides, alpha-sulfonated fatty acid methyl esters, alkyl polyglycosides, alcohol ethoxylates, sulfosuccinates, betaines, polyethylene glycols, polyoxyethylene fatty alcohol ethers, fatty alcohols, borates, silicates, carbonates, bicarbonates, phosphates, citrates, tetrasodium ethylene diamine tetraacetate, trisodium nitrilotriacetate, sodium polyacrylate, fragrances, and dyes, and mixtures thereof comprising sulfonates, sulfates, alcohol ethxylates and nonionic materials;
b. melting a fabric softener composition, said composition including ingredients selected from the group consisting of quaternary surfactants, fatty alcohols, starches, fragrances, polyethylene glycols, waxes, dyes, and silicones, and mixtures thereof;
c. supplying a length of nonwoven substrate having a non-uniform cross-section, said substrate comprised of at least two average fiber diameters carded into at least two webs that are laminated together and thermally or powder/thermally processed to create a flat side comprised primarily of smaller denier and more tightly bonded fibers and a lofted side comprised primarily of larger denier and more loosely bonded fibers constructed of carded fibers layers having a non-uniform cross-section and both a flat side and a lofted side; and,
d. coating said lofted side of said substrate with both the molten detergent composition and the molten fabric softener composition into at least one zone each and allowing the resulting detergent and fabric softener composition zones to, cool and solidify on the substrate.

33. A method of washing and conditioning fabrics comprising the steps of:
a. supplying the laundry article of claim 1;
b. washing a load of fabrics in a laundry machine with said article;
c. removing the washed fabrics from said laundry machine along with said article;
d. transferring the fabrics into the dryer along with said article; and,
e. drying said fabrics in the dryer along with said article.

34. A method of washing and conditioning fabrics comprising the steps of:
a. supplying the laundry article of claim 9;
b. washing a load of fabrics in a laundry machine with said article;
c. removing the washed fabrics from said laundry machine along with said article;
d. transferring the fabrics into the dryer along with said article; and,
e. drying said fabrics in the dryer along with said article.

35. A method of washing and conditioning fabrics comprising the steps of
a. supplying the laundry article of claim 19;
b. washing a load of fabrics in a laundry machine with said article;
c. removing the washed fabrics from said laundry machine along with said article;
d. transferring the fabrics into the dryer along with said article; and,
e. drying said fabrics in the dryer along with said article.

36. A method of washing and conditioning fabrics comprising the steps of:
a. supplying the laundry article of claim 22;
b. washing a load of fabrics in a laundry machine with said article;
c. removing the washed fabrics from said laundry machine along with said article;
d. transferring the fabrics into the dryer along with said article; and,
e. drying said fabrics in the dryer along with said article.
